(19) United States
(12) Patent Application Publication
(10) Pub. No.: US 2018/0300140 A1
(43) Pub. Date: Oct. 18, 2018

(54) INFORMATION PROCESSING APPARATUS, INFORMATION PROCESSING METHOD, AND NON-TRANSITORY COMPUTER-READABLE STORAGE MEDIUM

(71) Applicant: FUJITSU LIMITED, Kawasaki-shi (JP)

(72) Inventor: Munenori MAEDA, Yokohama (JP)

(73) Assignee: FUJITSU LIMITED, Kawasaki-shi (JP)

(21) Appl. No.: 15/950,221

(22) Filed: Apr. 11, 2018

(30) Foreign Application Priority Data
Apr. 14, 2017 (JP) 2017-080526

(51) Int. Cl. G06F 9/32; G06F 9/30

(52) U.S. Cl. CPC G06F 9/32; G06F 9/3004

(57) ABSTRACT

An information processing apparatus including a first memory, a plurality of first processors coupled to the first memory and the plurality of first processors configured to execute a first process including acquiring each of a plurality of processing demands, and allocating a sequential number to the plurality of processing demands in accordance with an order in which the plurality of processing demands are stored in a first memory, a second memory, and a second processor coupled to the second memory and the second processor configured to execute a second process including storing, into the second memory, the plurality of processing demands in accordance with the allocated sequential number, acquiring the plurality of processing demands stored in the second memory in accordance with an order in which the plurality of processing demands are stored in the second memory, and executing a processing corresponding to each of the plurality of processing demands.

### CROSS-REFERENCE TO RELATED APPLICATION

This application is based upon and claims the benefit of priority of the prior Japanese Patent Application No. 2017-80526, filed on Apr. 14, 2017, the entire contents of which are incorporated herein by reference.

### FIELD

The embodiments discussed herein are related to an information processing apparatus, an information processing method, and a non-transitory computer-readable storage medium.

### BACKGROUND

In information processing apparatuses, two methods called a polling process and an interrupt process are present as a method in which a central processing unit (CPU) acquires requests made to a device, such as InfiniBand or non-volatile memory express (NVMe). The requests are I/O requests, for example, reading, writing, receiving, and transmitting data. The polling process is a method in which the CPU periodically searches for and acquires a request held in each device. Moreover, the interrupt process is a method in which a device having acquired a request notifies a CPU of the occurrence of the request, and the CPU having been notified acquires the request.

When the CPU has a processing speed faster than that of the device, acquiring a request using the interrupt process is effective. Meanwhile, the remarkable improvement in the processing speed of the devices in recent years results in an increased number of information processing apparatuses in which the CPU acquires the requests by performing polling.

Moreover, more and more information processing apparatuses such as storage apparatuses include multiple CPUs or a CPU including multiple cores mounted therein. The following explanation is made for an example in which each CPU is an operation subject, but the same also holds in a case where each of cores mounted in one CPU is an operation subject. An information processing apparatus including multiple CPUs implements the leveling of polling processes among the CPUs such that all the CPUs execute polling to the devices.

Each device includes a request queue as a buffer that stores requests, and a response queue as a buffer that stores a response result for each request. For example, in a reception process of the InfiniBand, a device of the InfiniBand stores a request received from the interconnect in a request queue. The CPU then reads the request from the request queue included in the device of the InfiniBand.

Meanwhile, in a device to be polled, requests are stored in the chronological order of reception in the request queue managed by the device. In this case, in the request queue, the order of transmission seen from an information processing apparatus as a sender of the requests is kept. A CPU that executes polling acquires the requests in the above order from the request queue included in the device, and stores the requests in a soft request queue included in an upper-level software stack such as an application. The upper-level software stack executes processes designated by the respective requests in the chronological order of storage of the requests in the soft request queue.

Herein, in a configuration in which multiple CPUs simply execute polling in parallel, the CPUs may change the order of requests acquired from the request queue when storing the requests in the soft request queue. The change of the order of the requests makes it difficult for some application to execute a proper process. Therefore, it is desirable that the information processing apparatus ensure the reliability with a configuration capable of keeping the CPUs from changing the order of requests acquired from the request queue in the soft request queue when storing the requests in the soft request queue.

As such a technique of maintaining the order of the requests, there is the related art in which when reserving resources, a certain processor executes a global lock if detecting a conflict, and reserves the resources if the global lock is successful. Moreover, there is also the related art in which processes are exclusively executed in the order according to order numbers added to the requests.

Related techniques are disclosed in, for example, Japanese Laid-open Patent Publication Nos. 2000-148516 and 7-191944.

### SUMMARY

According to an aspect of the disclosure, an information processing apparatus including a first memory, a plurality of first processors coupled to the first memory and the plurality of first processors configured to execute a first process, the first process including acquiring each of a plurality of processing demands stored in the first memory, and allocating a sequential number to the plurality of processing demands in accordance with an order in which the plurality of processing demands are stored in the first memory, a second memory, and a second processor coupled to the second memory and the second processor configured to execute a second process, the second process including storing, into the second memory, the plurality of processing demands in accordance with the allocated sequential number, acquiring the plurality of processing demands stored in the second memory in accordance with an order in which the plurality of processing demands are stored in the second memory, and executing a processing corresponding to each of the plurality of processing demands.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a system configuration diagram illustrating one example of an information processing system;

FIG. 2 is a block diagram of an information processing apparatus according to a first embodiment;

FIG. 3 is a diagram illustrating a relation between a request queue and requests;

FIG. 4 is a diagram illustrating one example of a request list;

FIG. 5 is a diagram schematically illustrating each relation between registration information and a request;

FIG. 6 is a diagram illustrating one example of an unprocessed request table;

FIG. 7 is a diagram illustrating a transition of an individual request list when a request is received;

FIG. 8 is a diagram illustrating one example of a request sorting table;

FIG. 9 is a diagram illustrating a transition of the request sorting table when a request is received;

FIG. 10 is a diagram schematically illustrating a relation among the respective tables and registration information in the individual request list;

FIG. 11 is a diagram illustrating one example of states of the respective tables and request lists when the reception of a request is repeated;

FIG. 12 is a flowchart representing an overall process when a request is received by the information processing apparatus according to the first embodiment;

FIG. 13 is a flowchart of a request acquiring process using the exclusive control;

FIG. 14 is a flowchart of a creation process of an unprocessed request table, a request list, and a request sorting table;

FIG. 15 is a flowchart of a change process of an unprocessed request table, a request list, and a request sorting table, after a request is stored in a soft request queue;

FIG. 16 is a block diagram of an information processing apparatus according to a second embodiment;

FIG. 17 is a diagram illustrating one example of a delay core management table;

FIGS. 18A and 18B are diagrams illustrating a flowchart of a sorting process of requests in which the acquisition of the request by an application serves as a trigger;

FIG. 19 is a flowchart of a delay core set generating process;

FIG. 20 is a diagram of one example of a sequence counter according to a third embodiment;

FIG. 21 is a diagram of one example of an unprocessed request table according to the third embodiment;

FIG. 22 is a diagram of one example of a request sorting table according to the third embodiment;

FIG. 23 is a flowchart of an acquiring process of a request using the exclusive control by the information processing apparatus according to the third embodiment; and

FIG. 24 is a hardware configuration diagram of the information processing apparatus.

### DESCRIPTION OF EMBODIMENTS

If a reception process of acquiring a request is executed as an exclusive process, however, an execution of the reception process on a specific request queue by a certain one of CPUs forces the other CPUs to wait to perform the reception process on the request queue until the certain CPU completes the execution. Accordingly, all the CPUs actually execute the processes in series, which consumes a long time for the processes. Moreover, in the case of the polling, a request is read after the request queue is locked, and therefore the exclusive control may be performed even if no request is arrived. The exclusive control executed by the polling is a heavy process in terms of the mechanism, which imposes a large load on the information processing apparatus even when the polling is useless because of no request arrived, and may lower the performance of the information processing apparatus.

Moreover, even if the related art in which a global lock is executed when a conflict is detected or the related art in which processes are exclusively executed in the order according to the order numbers is used, the exclusive control is performed during a period when a request is acquired, so that it is difficult to perform the process speedily.

The embodiments discussed herein are made in view of the above circumstances, and aim to provide an information processing apparatus, an information processing method, and an information processing program that execute a process with high reliability and at high speed.

With one aspect, the embodiments discussed herein may execute a process with high reliability and at high speed.

Hereinafter, the embodiments of an information processing apparatus, an information processing method, and an information processing program discussed herein are described in details based on the drawings. Note that, the following embodiments do not intend to limit the information processing apparatus, the information processing method, and the information processing program discussed herein.

### First Embodiment

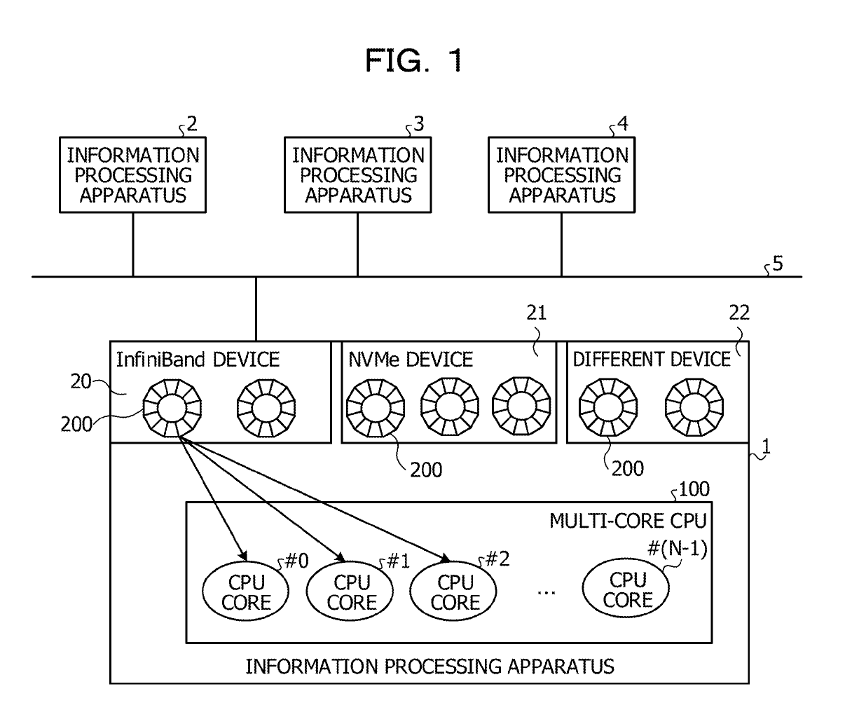

FIG. 1 is a system configuration diagram illustrating one example of an information processing system. The information processing system according to a first embodiment includes, for example, as illustrated in FIG. 1, multiple information processing apparatuses 1 to 4, which are coupled to one another via an interconnect 5 of InfiniBand.

The information processing apparatus 1 is, for example, a storage apparatus. Moreover, the information processing apparatuses 2 to 4 are, for example, servers. The information processing apparatus 1 is communicable with the information processing apparatuses 2 to 4 via the interconnect 5.

The information processing apparatus 1 includes an InfiniBand device 20, an NVMe device 21, and a different device 22. Moreover, the information processing apparatus 1 includes a multi-core CPU 100.

The InfiniBand device 20 is a device having an interface function for InfiniBand that transmits and receives data via the interconnect 5. The InfiniBand device 20 includes one or multiple request queues 200. Moreover, the InfiniBand device 20 includes a response queue corresponding to each request queue 200, however, the response queue is not illustrated in FIG. 1. The request queue 200 of the InfiniBand device 20 stores therein, for example, requests transmitted from the information processing apparatuses 2 to 4 to the information processing apparatus 1. The request queue 200 stores therein the requests by keeping the transmission order of the requests transmitted from the information processing apparatuses 2 to 4. This request queue 200 corresponds to one example of the “first storing unit”.

The NVMe device 21 is, for example, an auxiliary storage device to which many solid state drives (SSDs) are mounted. The NVMe device 21 also includes one or multiple request queues 200. Moreover, the NVMe device 21 also includes a response queue corresponding to each request queue 200, however, the response queue is not illustrated in FIG. 1. The request queue 200 of the NVMe device 21 stores therein, for example, a request that is transmitted from any one of CPU cores #0 to #(N−1) that executes a predetermined application.

The different device 22 also includes one or multiple request queues 200. The different device 22 may be a device that transmits and receives requests to and from the CPU cores #0 to #(N−1), for example, an Ethernet (registered trademark) device. The different device 22 also includes a response queue corresponding to each request queue 200, however, the response queue is not illustrated in FIG. 1.

The multi-core CPU 100 includes the CPU cores #0 to #(N−1). Each of the CPU cores #0 to #(N−1) has the same function, and thus is hereinafter expressed as a CPU core #100 in some cases unless each of the CPU cores #0 to #(N−1) is distinguished.

The CPU core #100 executes a polling process on any one of the InfiniBand device 20, the NVMe device 21, and the different device 22. The CPU core #100 then acquires a request stored in the request queue 200, and executes a process in accordance with the acquired request. Some CPU cores, out of the CPU cores #0 to #(N−1), execute polling processes on the same request queue 200 at the overlapping timing, in some cases. For example, FIG. 1 illustrates a state where the CPU cores #0 to #2 simultaneously execute polling processes on one request queue 200 of the InfiniBand device 20.

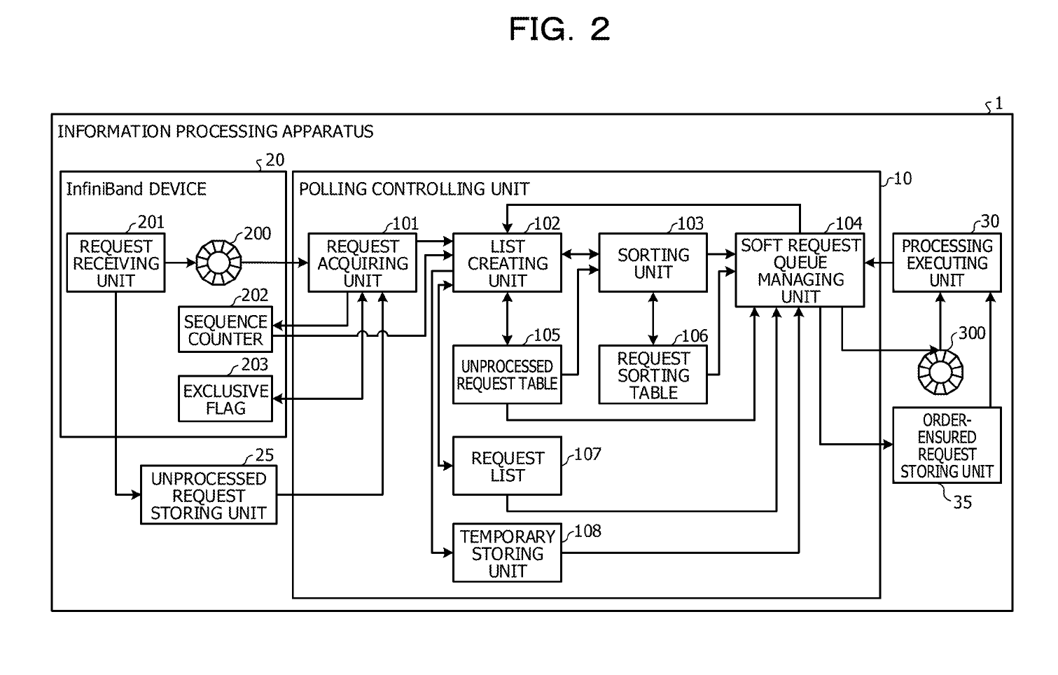

Next, with reference to FIG. 2, the movement of a request from the request queue 200 to a soft request queue 300 in the information processing apparatus 1 is described. FIG. 2 is a block diagram of the information processing apparatus according to the first embodiment. Herein, the request queue 200 included in the InfiniBand device 20 is described as an example.

The information processing apparatus 1 includes, as illustrated in FIG. 2, a polling controlling unit 10, the InfiniBand device 20, an unprocessed request storing unit 25, a processing executing unit 30, an order-ensured request storing unit 35, and the soft request queue 300.

The InfiniBand device 20 includes the request queue 200, a request receiving unit 201, a sequence counter 202, and an exclusive flag 203. Although one request queue 200 is herein illustrated in FIG. 2, when multiple the request queues 200 is present, one sequence counter 202 and one exclusive flag 203 are provided for each of the request queues 200.

The request receiving unit 201 receives a request via the interconnect 5. The request receiving unit 201 then stores the received request in the unprocessed request storing unit 25, and stores a pointer indicating a storage location of the request in the request queue 200.

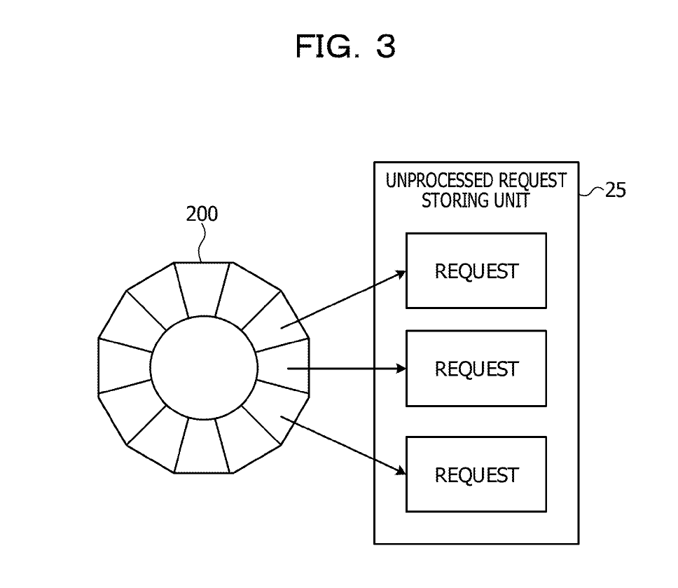

FIG. 3 is a diagram illustrating a relation between a request queue and requests. In the request queue 200 illustrated in FIG. 3, regions each of which stores therein a pointer indicating each request are illustrated in a divided manner, for easy understanding. The pointer stored in each region of the request queue 200 includes information indicating a request stored in the unprocessed request storing unit 25. In other words, pointers stored in the request queue 200 correspond to requests stored in the unprocessed request storing unit 25 on a one-to-one basis. The pointers are read from the request queue 200 in the order stored. Accordingly, the order of the pointers that are stored in the request queue 200 corresponds to the order of the requests that are stored in the unprocessed request storing unit 25.

Referring back to FIG. 2, the explanation is continuously made. The sequence counter 202 is a counter that sequentially holds sequential numbers. The counter of the sequence counter 202 is incremented by a request acquiring unit 101, which is described later.

The exclusive flag 203 has a value indicating whether the exclusive control on the request queue 200 is performed. The value of the exclusive flag 203 is changed by the request acquiring unit 101, which is described later. Hereinafter, “in-use” indicates a state where the exclusive control is being performed, and “unused” indicates a state where no exclusive control is being performed.

The soft request queue 300 is a request queue that an application uses for executing a process. The soft request queue 300 stores therein a pointer indicating a request having been stored in the order-ensured request storing unit 35 by a soft request queue managing unit 104, which is described later. This soft request queue 300 corresponds to one example of the “second storing unit”.

The order-ensured request storing unit 35 stores therein a request indicted by the pointer having been stored in the soft request queue 300, by the soft request queue managing unit 104, which is described later.

The relation between the soft request queue 300 and the requests stored in the order-ensured request storing unit 35 is similar to the relation between the request queue 200 and the requests stored in the unprocessed request storing unit 25 illustrated in FIG. 2. In other words, the pointers stored in the soft request queue 300 correspond to the requests stored in the order-ensured request storing unit 35 on a one-to-one basis. The pointers are read from the soft request queue 300 in the order stored. Accordingly, the order of the pointers that are stored in the soft request queue 300 corresponds to the order in which the requests stored in the order-ensured request storing unit 35 are processed by the application. Herein, although requests are actually stored in the order-ensured request storing unit 35, in order to express that the requests are stored in a state where the order thereof is being maintained, storage of the pointers in the soft request queue 300 and storage of the requests in the order-ensured request storing unit 35 are collectively called storage in the soft request queue 300 in some cases.

The processing executing unit 30 executes an application. The processing executing unit 30 sequentially reads the pointers that are stored in the soft request queue 300, in the order stored. The processing executing unit 30 then acquires the request that is indicated by the read pointer and stored in the order-ensured request storing unit 35. The processing executing unit 30 executes a process in accordance with the acquired request. In other words, the processing executing unit 30 executes the requests that are stored in the order-ensured request storing unit 35, in accordance with the order of the pointers that are stored in the soft request queue 300.

The polling controlling unit 10 includes the request acquiring unit 101, a list creating unit 102, a sorting unit 103, and the soft request queue managing unit 104. The polling controlling unit 10 further includes an unprocessed request table 105, a request sorting table 106, a request list 107, and a temporary storing unit 108.

The request acquiring unit 101 has a function of acquiring a request, which is implemented by the CPU cores #0 to #(N−1). The following process is executed by any one of the CPU cores #0 to #(N−1). Hereinafter, the CPU cores #0 to #(N−1) are distinguished respectively by core numbers #0 to #(N−1), in some cases. The request acquiring unit 101 has timing of executing polling in advance. When the timing of executing polling arrives, the request acquiring unit 101 checks the exclusive flag 203. If a value of the exclusive flag 203 indicates in-use, the request acquiring unit 101 ends the process without executing the polling.

In contrast, if a value of the exclusive flag 203 indicates unused, the request acquiring unit 101 changes the value of the exclusive flag 203 to in-use. With this, the request queue 200 is locked. In other words, when the CPU core #0 changes the value of the exclusive flag 203 to in-use, the CPU cores #1 to #(N−1) other than the CPU core #0 is caused to wait for timing to access the request queue 200.

After the request queue 200 is locked, the request acquiring unit 101 executes a process of reading a pointer that is stored oldest in the request queue 200, and acquiring a request corresponding to the read pointer from the unprocessed request storing unit 25. Herein, if a request is not acquired, the request acquiring unit 101 ends the process, and sets again the value of the exclusive flag 203 to unused.

In contrast, if a request is acquired, the request acquiring unit 101 increments the value of the sequence counter 202 by one. The request acquiring unit 101 then outputs the acquired request to the list creating unit 102. Thereafter, the request acquiring unit 101 sets again the value of the exclusive flag 203 to unused.

In this manner, each of the CPU cores #0 to #(N−1) in the request acquiring unit 101 performs the exclusive control while acquiring a request and setting a number corresponding to the acquired request. This exclusive control by the request acquiring unit 101 is called trylock in some cases, which is control to be skipped when the lock is failed. The CPU cores #0 to #(N−1) correspond to one example of the processing units. Moreover, the request acquiring unit 101 corresponds to one example of the “processing demand acquiring unit”.

The list creating unit 102 receives an input of a request from the request acquiring unit 101. The list creating unit 102 then acquires a value of the sequence counter 202, and sets the acquired value as an order number of the acquired request.

Next, the list creating unit 102 stores the acquired request in the temporary storing unit 108. Next, the list creating unit 102 registers registration information in which the order number includes information on a storage location of the request, to a list corresponding to the CPU core #0 having read the request, in the request list 107. Hereinafter, creation of a list by the list creating unit 102 is described in details.

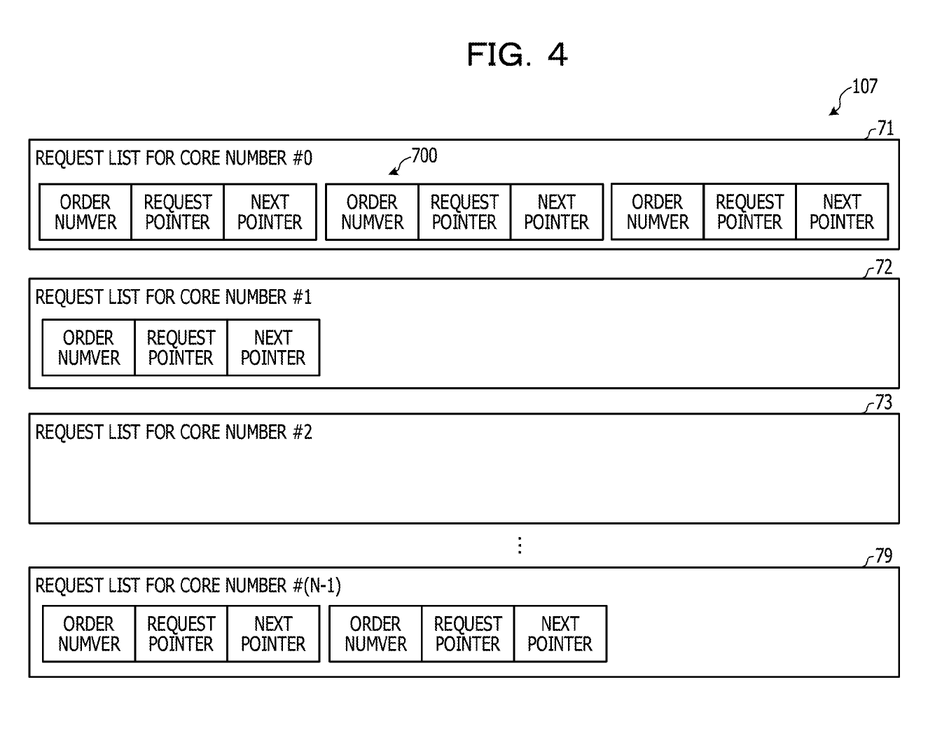

FIG. 4 is a diagram illustrating one example of a request list. The request list 107 includes a list for each of the CPU cores #0 to #(N−1). In other words, as illustrated in FIG. 4, the request list 107 includes a request list 71 for the core number #0, a request list 72 for the core number #1, a request list 73 for the core number #2, a request list 79 for the core number #(N−1), and the like. Hereinafter, when the lists for the respective CPU cores #0 to #(N−1) are not distinguished, the list is referred to as “individual request list 70”.

The list creating unit 102 registers registration information 700 to the individual request list 70. The registration information 700 includes an order number, a request pointer, and a next pointer. The order number corresponds to the order number that is allocated to the request acquiring unit 101 by the list creating unit 102. The request pointer is information indicating a storage location of a request corresponding to the order number, in the temporary storing unit 108. Moreover, the next pointer is information representing registration information 700 that is registered next in the same individual request list 70.

In other words, the list creating unit 102 stores a request that is acquired from the request acquiring unit 101 in the temporary storing unit 108, and generates the registration information 700 including an order number of the stored request and a request pointer indicating a storage location thereof. In addition, the list creating unit 102 adds information representing an end, as a next pointer, to the generated registration information 700. Thereafter, the list creating unit 102 registers the generated registration information 700 to the individual request list 70 corresponding to a reading source of the request. In addition, when the individual request list 70 already includes the registration information 700, the list creating unit 102 changes a next pointer of the oldest registration information 700, out of the registration information 700 having been already registered, to a value indicating the registration information 700 registered this time. With this, the individual request list 70 is created as a list including the registration information 700 arranged so as to indicate the order of the read requests, for each of the CPU cores #0 to #(N−1). For example, in FIG. 4, three pieces of the registration information 700 are present in the request list 71 for the core number #0. In other words, this is a state where the CPU core #0 has read three requests. Moreover, one piece of the registration information 700 is present in the request list 72 for the core number #1. In other words, this is a state where the CPU core #1 has read one request. Moreover, no registration information 700 is present in the request list 73 for the core number #2. In other words, this is a state where the CPU core #2 has read no request.

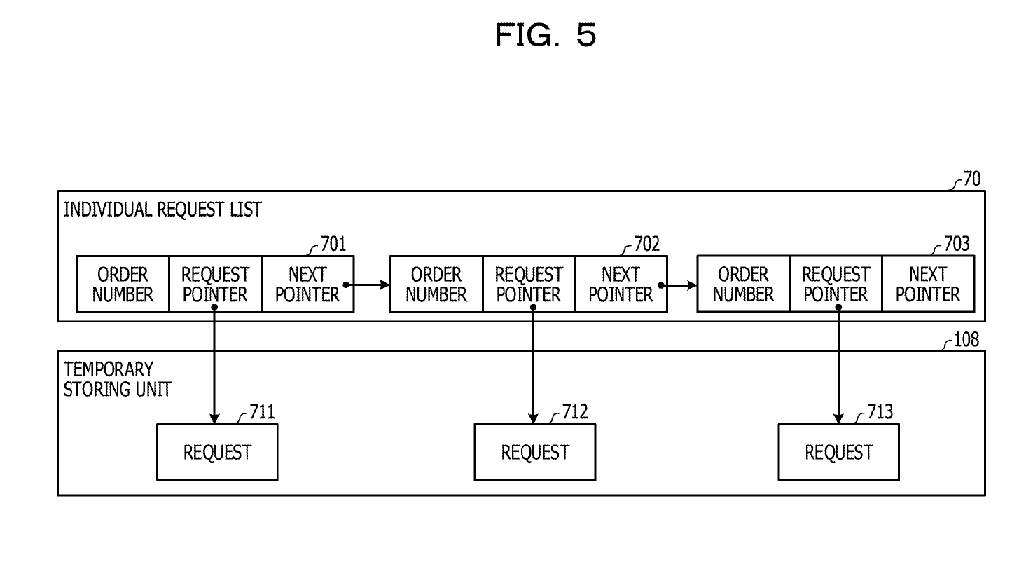

FIG. 5 is a diagram schematically illustrating each relation between registration information and a request. In this case, registration information 701 is the oldest registration information 700 that is registered to the individual request list 70. A request pointer of the registration information 701 indicates a request 711 that is stored in the temporary storing unit 108. Moreover, registration information 702 that is indicated by a next pointer of the registration information 701 is the registration information 700 that is next registered to the individual request list 70 after the registration information 701. A request pointer of the registration information 702 indicates a request 712 that is stored in the temporary storing unit 108. Further, registration information 703 indicated by a next pointer of the registration information 702 is the latest registration information 700 that is registered to the individual request list 70. A request pointer of the registration information 703 indicates a request 713 that is stored in the temporary storing unit 108. In this manner, pieces of the registration information 700 that are connected by the next pointers as a chain become a list in which request pointers are arranged so as to indicate the requests in the order read. This makes it impossible to arrange registration information 700 having a certain order number before registration information 700 having an order number older than the certain order number.

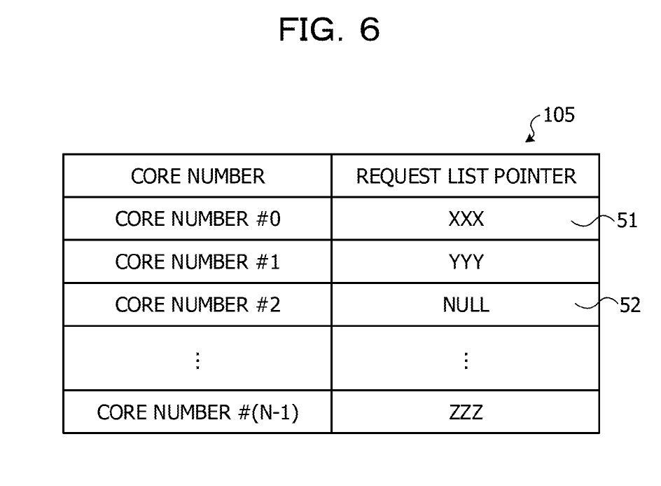

Next, the list creating unit 102 reads the stored request, and registers a pointer to the individual request list 70 to an item of the unprocessed request table 105 corresponding to the CPU core #100. FIG. 6 is a diagram illustrating one example of an unprocessed request table.

As illustrated in FIG. 6, request list pointers corresponded to the core numbers #0 to #(N−1) indicating the CPU cores #0 to #(N−1) are registered to the unprocessed request table 105. The request list pointer indicates head registration information, out of the registration information registered to the individual request list 70 of the corresponding CPU core #100, in other words, the oldest registration information. Hereinafter, details of registration of a request list pointer to the unprocessed request table 105 by the list creating unit 102 are described.

The list creating unit 102 checks whether a request list pointer corresponding to the CPU core #100 having read a stored request in the unprocessed request table 105 is registered. If registration information is already registered to the individual request list 70 for the CPU core #100 having read the stored request, information indicating the head registration information has been already registered to the unprocessed request table 105, as a request list pointer.

In contrast, if a request list pointer is not registered, which corresponds to a case where the registration information 700 is registered for the first time to the individual request list 70 for the CPU core #100 having read the stored request. In this case, the list creating unit 102 notifies the sorting unit 103 of an order number of the stored request and information on the CPU core #100 having read the request.

In addition, the list creating unit 102 registers information indicating the registration information 700 indicating the stored request, as a request list pointer corresponding to the CPU core #100 having read the stored request, to the unprocessed request table 105.

For example, a request list pointer 51 indicates the head registration information in the request list 71 for the core number #0 illustrated in FIG. 4. Moreover, no registration information 700 is registered to the request list for the core number #2 illustrated in FIG. 4. In that case, a request list pointer 52 is empty. In the first embodiment, NULL is registered, as information representing the request list pointer 52 being empty.

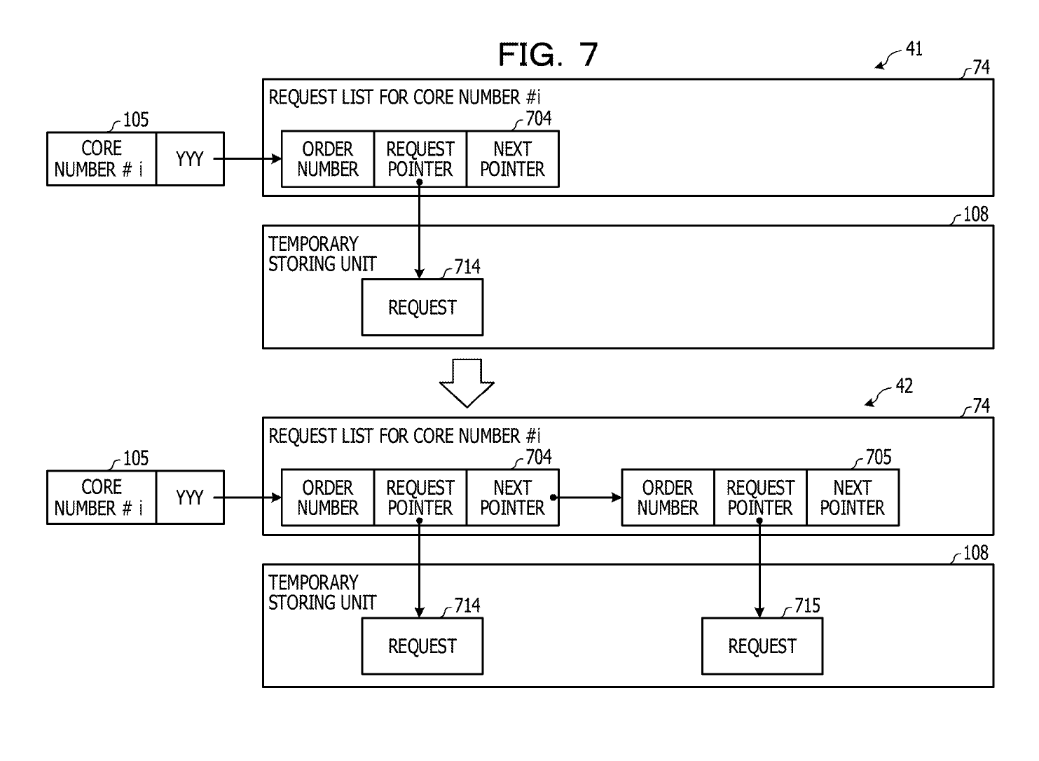

FIG. 7 is a diagram illustrating a transition of an individual request list when a request is received. For example, a case where a CPU core #i reads a request 715 is described. In FIG. 7, an entry of a core number #i of the unprocessed request table 105 is taken out and illustrated. A state 41 represents a state before the reception of a request. In other words, the state before the reception of a request is a state where information representing registration information 704 with a request list pointer in the entry of the core number #i is stored in a request list 74 for the core number #i. Further, a request pointer of the registration information 704 indicates a request 714 that is stored in the temporary storing unit 108. Further, as illustrated in a state 42, the list creating unit 102 stores the request 715 read by the CPU core #i in the temporary storing unit 108. The list creating unit 102 then resisters registration information 705 to the request list 74 for the core number #i, and causes a next pointer of the registration information 704 to indicate the registration information 705. With this, the registration information 704 and the registration information 705 are associated with each other in sequence in the entry of the core number #i of the unprocessed request table 105.

Moreover, when a storage process into the soft request queue 300 is performed for a request that is stored in the temporary storing unit 108 by the soft request queue managing unit 104, which is described later, the list creating unit 102 executes the following process. The list creating unit 102 acquires information on the individual request list 70 that stores therein the registration information 700 indicating the request having been stored in the soft request queue 300, from the soft request queue managing unit 104. Next, the list creating unit 102 specifies the CPU core #100 corresponding to the individual request list 70 indicated by the acquired information. This specified CPU core #100 is referred to as a target CPU core #100.

Next, the list creating unit 102 checks a next pointer of the head registration information 700 in the individual request list 70. If the next pointer is not a value representing the end, the list creating unit 102 specifies the registration information 700 indicated by the next pointer. The list creating unit 102 then changes a request list pointer in the entry of the target CPU core #100 in the unprocessed request table 105 so as to indicate the specified registration information 700.

In contrast, if the next pointer is a value representing the end, the list creating unit 102 sets NULL representing being empty as a value of the request list pointer in the entry of the target CPU core #100 in the unprocessed request table 105.

Thereafter, the list creating unit 102 deletes the head registration information 700 in the individual request list 70. In addition, the list creating unit 102 notifies the sorting unit 103 of information on the target CPU core #100 and information on the deleted head registration information 700 in the individual request list 70 of the target CPU core #100. This list creating unit 102 corresponds to one example of the “managing unit”.

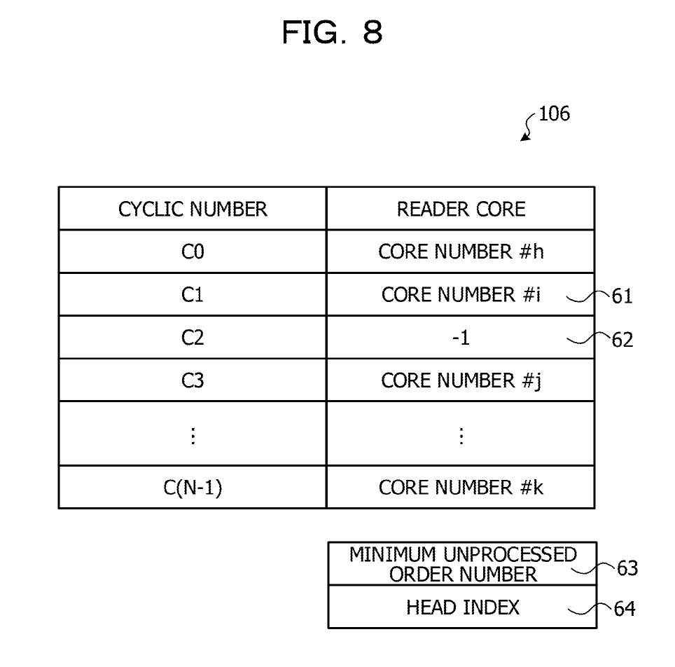

Next, the request sorting table 106 is described. FIG. 8 is a diagram illustrating one example of a request sorting table. In the request sorting table 106, by being corresponded to a cyclic number representing an order number, a core number representing the CPU core #100 that has read a request including the order number represented by the cyclic number is registered as a reader core. For example, as a reader core 61 corresponding to a cyclic number C1, the core number #i is registered.

Moreover, in a case where a request including an order number represented by a specific cyclic number is not yet registered, −1 is registered as a reader core in the entry of the specific cyclic number. It may be considered that the case where a request including an order number represented by a specific cyclic number is not yet registered is a case where the request acquiring unit 101 has not yet performed reading from the request queue 200, for example. Moreover, it may be also considered to be a case where the request acquiring unit 101 has already performed the reading, but the registration by the sorting unit 103 is delayed. For example, as a reader core 62 corresponding to a cyclic number C2, −1 is registered.

Herein, in the first embodiment, as an item representing the cyclic number in the request sorting table 106, items the number of which is the same as the number of the CPU cores #0 to #(N−1) are set. Further, the cyclic number in the request sorting table 106 changes such that the cyclic number sequentially moves from the head entry, and when reaching the entry of the last cyclic number, returns to the head entry. Further, the order number corresponding to the cyclic number having returned to the head cyclically changes such that the entries represent continuous numbers from the next order number from the order number corresponding to the last cyclic number before the return. For example, in the request sorting table 106 of FIG. 8, items corresponding to cyclic numbers C0 to C(N−1) are present. Further, the respective cyclic numbers represent the entries of order numbers ##0 to ##(N−1) in the first round, the entries of order numbers ##N to ##(2N−1) in the second round, and the entries of order numbers ##3N to ##(3N−1) in the third round.

In addition, the request sorting table 106 includes a minimum unprocessed order number 63 and a head index 64. The minimum unprocessed order number 63 is an order number of a request including the minimum order number, out of requests the storage process into the soft request queue 300 of which has not yet been completed. In other words, when the storage process into the soft request queue 300 is already completed up to the order number ##(N−1), the minimum unprocessed order number 63 is the order number ##N. Moreover, the head index 64 represents a cyclic number to be processed next on the request sorting table 106. In other words, the head index 64 represents a cyclic number corresponding to the order number represented by the minimum unprocessed order number 63.

Herein, in the first embodiment, as for the CPU core #100 that is registered as a reader core of the request sorting table 106, each one CPU core #100 is registered on the request sorting table 106. Therefore, in the first embodiment, the number of the entries on the request sorting table 106 is the same number of the number of the CPU cores #0 to #(N−1). However, the number of entries in the request sorting table 106 is not specially limited. Moreover, if the resource such as a memory area allows, without using the cyclic number, the number of entries in the request sorting table 106 may be set to the same number as the number of requests to which order numbers are allocated, and reader cores corresponding to all the order numbers may be registered while allowing reader cores to be overlapped with other.

The sorting unit 103 sets the index 64 representing the head to the item that corresponds to an order number of the first request in the request sorting table 106 illustrated in FIG. 8. The sorting unit 103 then sets a value of the minimum unprocessed order number 63 to a value indicating the order number of the first request. In addition, the sorting unit 103 sets the head index 64 to a value representing a cyclic number to which an index representing the head is set. Herein, the order number of the first request is set to ##0. Thereafter, the sorting unit 103 repeats a process described below.

The sorting unit 103 acquires an order number of a stored request and information on the CPU core #100 having read the request, from the list creating unit 102. Herein, described is a case where the sorting unit 103 acquires information on the CPU core #i as a reading source of the request, and acquires n as an order number of the request. The sorting unit 103 acquires a value of the minimum unprocessed order number 63. Next, the sorting unit 103 adds the number of items in the request sorting table 106 to the minimum unprocessed order number 63. The sorting unit 103 determines whether an addition result exceeds n that is the order number of the stored request. If the addition result exceeds n, the sorting unit 103 determines that the order number of the stored request is within the registration range of the request sorting table 106. This is because the request sorting table 106 includes cyclic numbers cyclically corresponding to order numbers, so that the registration of order numbers from the minimum unprocessed order number 63 to a value smaller by one than the number of items in the request sorting table 106 is possible.

If the order number of a stored request is out of the registration range of the request sorting table 106, the sorting unit 103 ends the sorting process.

In contrast, if the order number of the stored request is within the registration range of the request sorting table 106, the sorting unit 103 adds a value in which the minimum unprocessed order number 63 is subtracted from the order number of the stored request, to the head index 64. Next, the sorting unit 103 determines whether the addition result exceeds N that is the number of items in the request sorting table 106. If the addition result does not exceed N, the sorting unit 103 registers the core number #i as a reader core to the entry of a cyclic number of the value. In contrast, if the addition result exceeds N, the sorting unit 103 registers the core number #i as a reader core to the entry of a cyclic number in which N that is the number of items in the request sorting table 106 is subtracted from the addition result.

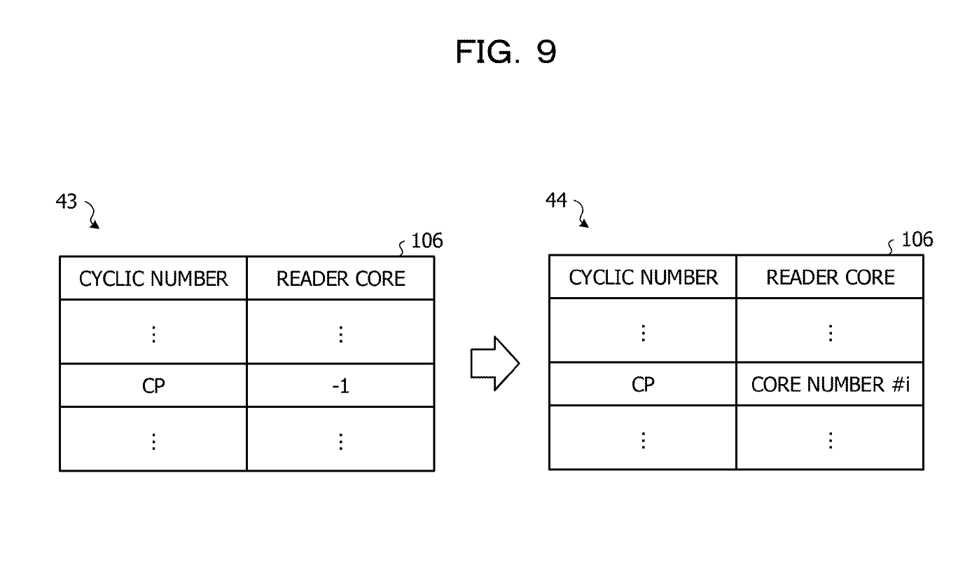

FIG. 9 is a diagram illustrating a transition of the request sorting table when a request is received. A state 43 indicates a state before the reception of a request. Moreover, a state 44 represents a state after the reception of the request. As indicated in the state 43, no reader core is registered in the entry of a cyclic number CP of the request sorting table 106, before the reception of a request.

Thereafter, the sorting unit 103 acquires an order number corresponding to the cyclic number CP and information that the CPU core #i has read a request including the order number, from the list creating unit 102. The sorting unit 103 then registers the core number #i as a reader core to the entry of a cyclic number corresponding to the acquired order number, in the request sorting table 106. This causes the request sorting table 106 to transit to the state 44.

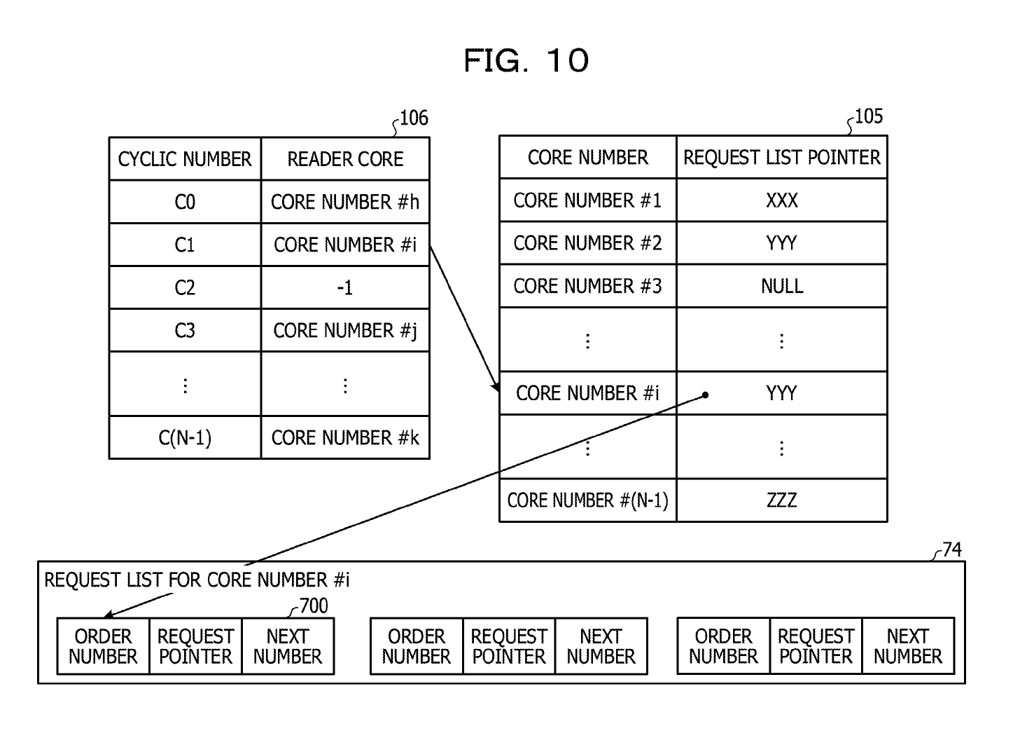

FIG. 10 is a diagram schematically illustrating a relation among the tables and registration information of the individual request list. Information on a reader core that is registered by the sorting unit 103 so as to be corresponded to a cyclic number in the request sorting table 106 corresponds to any one of core numbers in the entries in the unprocessed request table 105. Further, information on a request list pointer that is registered by the list creating unit 102 so as to be corresponded to the core number in the unprocessed request table 105 corresponds to the head registration information 700 of any one of the individual request lists 70.

For example, as illustrated in FIG. 10, when the core number #i is registered as a reader core corresponding to the cyclic number C1 in the request sorting table 106, this item corresponds to the entry of the core number #i in the unprocessed request table 105. Further, a request list pointer corresponding to the core number #i in the unprocessed request table 105 corresponds to the head registration information 700 in the request list 74 for the core number #i. In other words, when an order number is known, and the order number is stored in the request sorting table 106, it is possible to acquire a request including the order number. In this manner, the registration to the request sorting table 106 allows the sorting unit 103 to sequentially acquire requests. The registration to the request sorting table 106 is performed so as to allow the sorting unit 103 to sequentially acquire the requests in the order of order numbers, thus, it may be said the sorting unit 103 sorts requests in the order of order numbers.

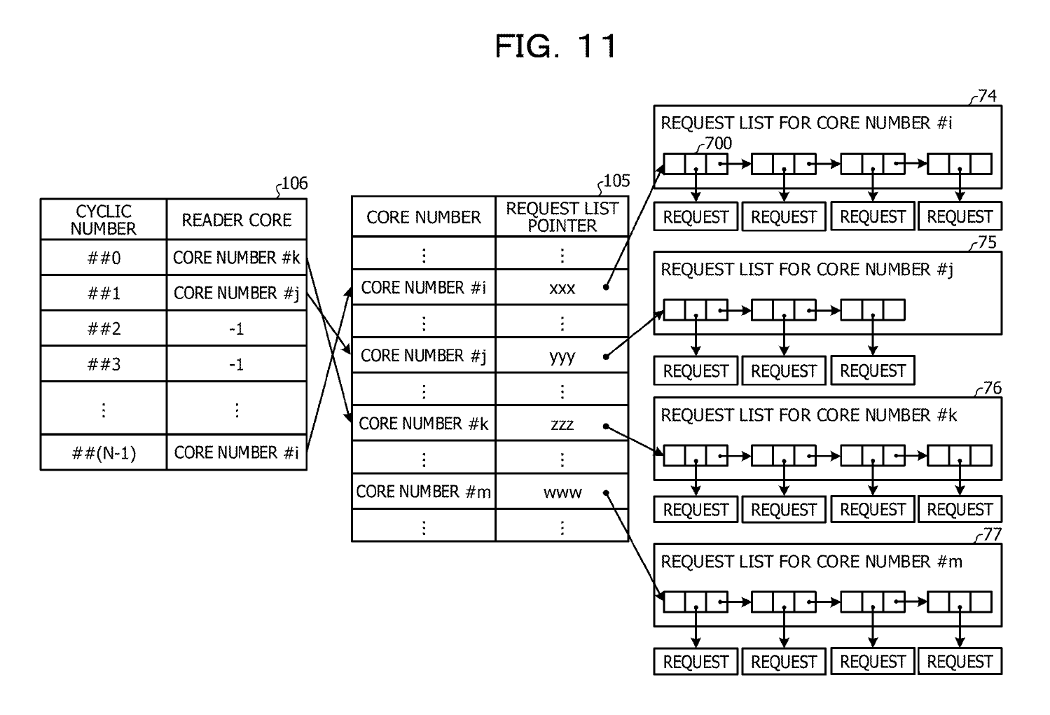

The list creating unit 102 and the sorting unit 103 repeat the processes of the creation of the request list 107, the registration of the unprocessed request table 105, and the sort of requests with the request sorting table 106, in response to the acquisition of a request by the request acquiring unit 101. The list creating unit 102 and the sorting unit 103 repeat these processes in response to the reception of a request, thereby generating a state illustrated in FIG. 11. FIG. 11 is a diagram illustrating one example of states of the tables and request lists when the reception of a request is repeated.

In the entry of the reader core of the request sorting table 106, the same value is not registered twice or more, except −1 representing that the registration information 700 is not yet registered to the individual request list 70. This is because a reader core is registered with respect to a cyclic number corresponding to an order number of a request that is indicated by the head registration information 700 of the individual request list 70 corresponding to each of the CPU cores #0 to #(N−1).

Further, request list pointers, in the entries of the unprocessed request table 105, corresponding to core numbers #k, #j, and #i that are registered as reader cores in the request sorting table 106 respectively indicate the head registration information 700 in the individual request lists 70. For example, in FIG. 11, the request list pointer in the entry of the core number #i indicates head registration information 700 in the request list 74 for the core number #i, and three pieces of the registration information 700 are registered so as to be connected in a line to the head registration information 700. Moreover, the request list pointer in the entry of the core number #j indicates head registration information 700 in a request list 75 for the core number #j, and two pieces of the registration information 700 are registered so as to be connected in a line to the head registration information 700. Moreover, the request list pointer in the entry of the core number #k indicates head registration information 700 in a request list 76 for the core number #k, and three pieces of the registration information 700 are registered so as to be connected in a line to the head registration information 700.

In addition, a core number #m that is not registered as a reader core in the request sorting table 106 but for which a request list pointer is registered, is present in the unprocessed request table 105. This indicates, for example, a case where a CPU core #m reads a delayed request the order number of which is out of the range of the request sorting table 106 at that time, or the like. In FIG. 11, a request list pointer corresponding to the core number #m that is not registered as a reader core in the request sorting table 106 indicates head registration information 700 in a request list 77 for the core number #m. Further, four pieces of the registration information 700 are registered so as to be connected in a line to the head registration information 700 in the request list 77 for the core number #m. As described above, such a CPU core #100 is present among the CPU cores #100, in which the registration information 700 is already registered to the corresponding individual request list 70, but the CPU core #100 is not registered to the request sorting table 106 as a reader core.

Referring back to FIG. 2, the explanation is continuously made. When a storage process into the soft request queue 300 is performed for a request that is stored in the temporary storing unit 108, the sorting unit 103 receives information on the target CPU core #100 that is a reader core of the request, from the list creating unit 102. In addition, the sorting unit 103 receives information on the head registration information 700 in the individual request list 70 of the target CPU core #100, from the list creating unit 102.

The sorting unit 103 changes the value of a reader core in the entry of a cyclic number indicated by the head index 64 at that time in the request sorting table 106 to −1. Next, the sorting unit 103 adds, for example, 1 to the value of the head index 64 to calculate a value indicating a next entry from the entry of the cyclic number indicated by the head index 64 at that time. The sorting unit 103 then determines whether the calculated value exceeds the number of entries in the request sorting table 106. If the calculated value does not exceed the number of entries in the request sorting table 106, the sorting unit 103 sets the calculated value to the value of the head index 64. In contrast, if the calculated value exceeds the number of entries in the request sorting table 106, the sorting unit 103 sets the head cyclic number of the request sorting table 106 to the value of the head index 64.

Moreover, the sorting unit 103 adds 1 to the minimum unprocessed order number 63 to change the minimum unprocessed order number 63 to a value indicating an order number of a next request from the request having been stored in the soft request queue 300.

Next, the sorting unit 103 determines whether the individual request list 70 of the target CPU core #100 is empty depending on whether the value of a request list pointer in the entry of the target CPU core #100 in the unprocessed request table 105 is NULL. If the individual request list 70 is empty, the sorting unit 103 ends the change processes of the unprocessed request table 105, the request sorting table 106, and the individual request list 70, when the request is stored in the soft request queue 300.

In contrast, if the individual request list 70 of the target CPU core #100 is not empty, the sorting unit 103 acquires an order number stored in the head registration information 700 of the individual request list 70. The sorting unit 103 then determines whether an addition result in which the number of entries in the request sorting table 106 is added to a value of the minimum unprocessed order number 63 is more than the acquired order number. If the addition result is less than the acquired order number, the order number is out of the registration range of the request sorting table 106, so that the sorting unit 103 ends the change process of the request sorting table 106.

In contrast, if the addition result is equal to or less than the acquired order number, the sorting unit 103 adds a value in which a value of the minimum unprocessed order number 63 is subtracted from the acquired order number, to the value of the head index 64. Next, the sorting unit 103 determines whether the addition result exceeds N that is the number of items in the request sorting table 106. If the addition result does not exceed N, the sorting unit 103 registers the target CPU core #100 as a reader core to the entry of a cyclic number of the value. In contrast, if the addition result exceeds N, the sorting unit 103 registers the target CPU core #100 as a reader core to the entry of a cyclic number in which N that is the number of items in the request sorting table 106 is subtracted from the addition result.

The soft request queue managing unit 104 acquires the head index 64 of the request sorting table 106, with a predetermined interval or a request acquisition demand from the processing executing unit 30 as a trigger. The soft request queue managing unit 104 then acquires a reader core in the entry of a cyclic number indicated by the head index 64.

Next, the soft request queue managing unit 104 acquires a request list pointer from the entry of the unprocessed request table 105 corresponding to the acquired reader core. The soft request queue managing unit 104 then reads head registration information 700 of the individual request list 70 indicated by the acquired request list pointer. Thereafter, the soft request queue managing unit 104 acquires a request indicated by a request pointer of the read registration information 700 from the temporary storing unit 108. The soft request queue managing unit 104 then stores the acquired request in the order-ensured request storing unit 35. In addition, the soft request queue managing unit 104 stores a pointer indicating the request having stored in the order-ensured request storing unit 35, at the tail end of the pointers that are stored in the soft request queue 300. This allows the processing executing unit 30 to read requests that are stored in the order-ensured request storing unit 35 in the order of pointers that are stored in the soft request queue 300. In other words, the order that requests stored in the order-ensured request storing unit 35 are read is the same as the order of the requests in a state being stored in the request queue 200.

Thereafter, the soft request queue managing unit 104 notifies the list creating unit 102 of information on the individual request list 70 in which the read request is stored.

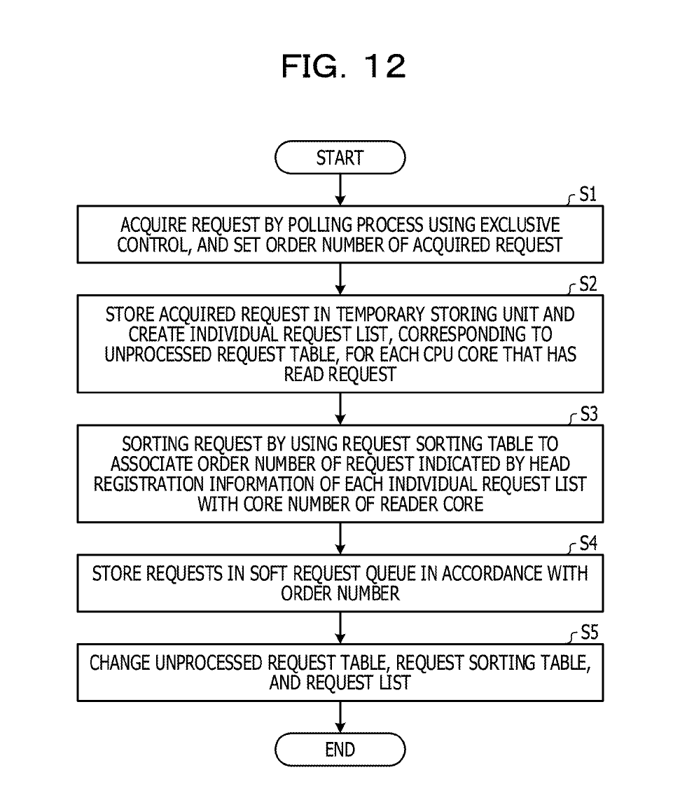

Next, with reference to FIG. 12, an overall flow of a process when a request is received according to the first embodiment is described. FIG. 12 is a flowchart representing an overall process when a request is received by the information processing apparatus according to the first embodiment.

The request acquiring unit 101 locks the request queue 200 and performs polling using the exclusive control to acquire a request indicated by a pointer stored in the request queue 200, from the unprocessed request storing unit 25. In addition, the request acquiring unit 101 sets an order number of the acquired request using the sequence counter 202 (Step S1). Thereafter, the request acquiring unit 101 outputs the acquired request to the list creating unit 102.

The list creating unit 102 receives an input of the request from the request acquiring unit 101. In addition, the list creating unit 102 acquires the order number from the sequence counter 202, and allocates the order number to the request. The list creating unit 102 stores the acquired request in the temporary storing unit 108. Moreover, the list creating unit 102 creates the individual request list 70 for each CPU core #100 that has read the request by corresponding to the unprocessed request table 105 (Step S2). The list creating unit 102 then outputs the order number of the stored request and information on the CPU core #100 having read the request, to the sorting unit 103.

The sorting unit 103 receives an input of the order number of the stored request and the information on the CPU core #100 having read the request, from the list creating unit 102. The sorting unit 103 then uses the request sorting table 106 to associate an order number of a request indicated by the head registration information of each individual request list 70 with a core number of the reader core, thereby sorting the requests (Step S3).

Thereafter, the soft request queue managing unit 104 stores the request having been stored in the temporary storing unit 108 in the soft request queue 300 in accordance with the order number (Step S4).

In response to the storing of the request to the soft request queue 300, the list creating unit 102 changes the unprocessed request table 105 and the request list 107. Moreover, in response to the change in the unprocessed request table 105 and the request list 107, the sorting unit 103 changes the request sorting table 106 (Step S5).

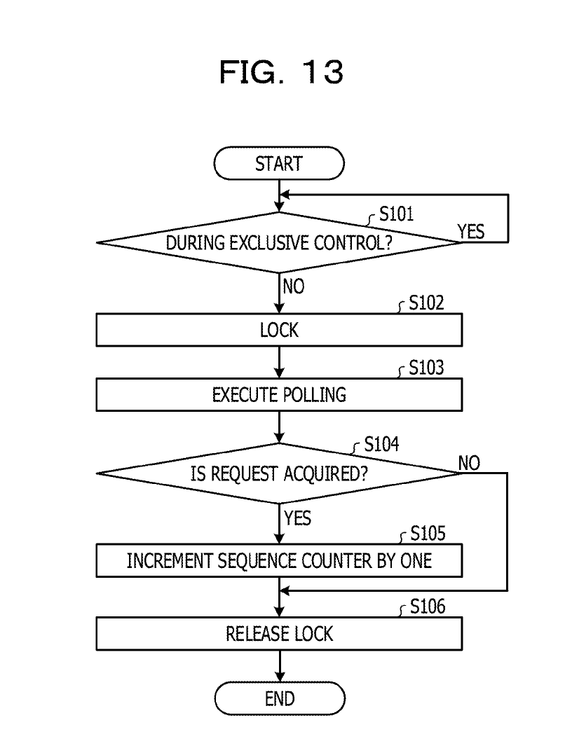

Next, a flow of a request acquiring process using the exclusive control is described with reference to FIG. 13. FIG. 13 is a flowchart of a request acquiring process using the exclusive control. The process indicated by the flowchart of FIG. 13 corresponds to one example of the process at Step S1 of FIG. 12.

The request acquiring unit 101 checks the exclusive flag 203, and determines whether the request queue 200 is in-use (Step S101). If the request queue 200 is in-use (Step S101: affirmative), the request acquiring unit 101 waits until the request queue 200 is out of use.

In contrast, if the request queue 200 is unused (Step S101: negative), the request acquiring unit 101 changes the value of the exclusive flag 203 to be in-use, and locks the request queue 200 (Step S102).

Next, the request acquiring unit 101 executes polling for the request queue 200 (Step S103).

The request acquiring unit 101 then determines whether a request is acquired (Step S104). If a request is not acquired (Step S104: negative), the request acquiring unit 101 causes the process to proceed to Step S106.

In contrast, if a request is acquired (Step S104: affirmative), the request acquiring unit 101 increments the sequence counter 202 by one (Step S105).

Thereafter, the request acquiring unit 101 sets again the value of the exclusive flag 203 to unused, and releases the lock on the request queue 200 (Step S106).

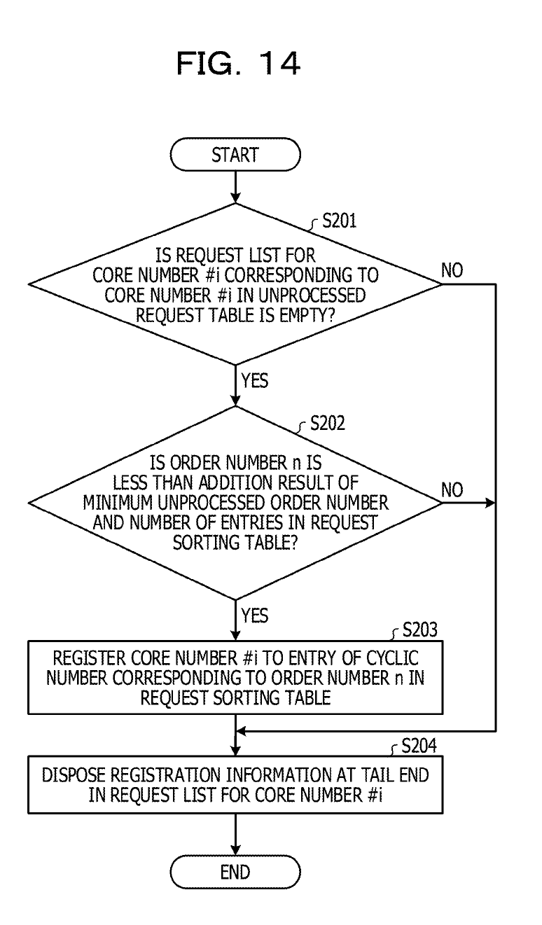

Next, a flow of creation processes of the unprocessed request table 105, the request list 107, and the request sorting table 106 is described with reference to FIG. 14. FIG. 14 is a flowchart of creation processes of an unprocessed request table, a request list, and a request sorting table. The process indicated by the flowchart of FIG. 14 corresponds to one example of the process at Steps S2 and S3 of FIG. 12. Herein, a case where the CPU core #i reads a request including an order number n is described.

The list creating unit 102 determines whether a value of a request list pointer corresponding to the core number #i in the unprocessed request table 105 is NULL, in other words, whether the request list 74 for the core number #i is empty (Step S201). If the request list 74 for the core number #i is not empty (Step S201: negative), the list creating unit 102 causes the process to proceed to Step S204.

In contrast, if the request list 74 for the core number #i is empty (Step S201: affirmative), the list creating unit 102 outputs the order number n of the stored request and information on the CPU core #i having read the request, to the sorting unit 103. The sorting unit 103 receives an input of the order number n of the stored request and the information on the CPU core #i having read the request, from the list creating unit 102. Next, the sorting unit 103 acquires the minimum unprocessed order number 63. The sorting unit 103 then determines whether the order number n is less than an addition result of the minimum unprocessed order number 63 and the number of entries in the request sorting table 106 (Step S202). If the order number n is equal to or more than the addition result (Step S202: negative), the process proceeds to Step S204.

In contrast, if the order number n is less than the addition result (Step S202: affirmative), the sorting unit 103 registers the core number #i to the entry of a cyclic number corresponding to the order number n, in the request sorting table 106 (Step S203).

The list creating unit 102 disposes registration information 700 indicating the stored request at the tail end of pieces of the registration information 700 connected in a line in the request list 74 for the core number #i (Step S204).

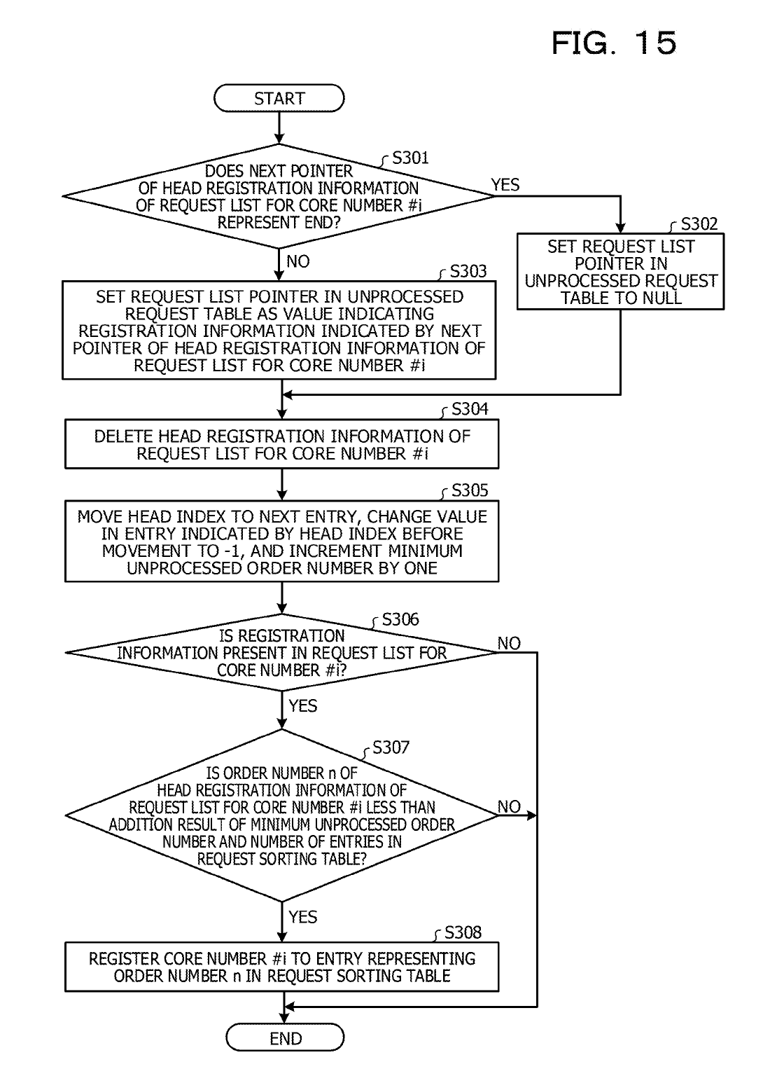

Next, a flow of a change process of the unprocessed request table 105, the request list 107, and the request sorting table 106, after the request is stored in the soft request queue 300, is described with reference to FIG. 15. FIG. 15 is a flowchart of a change process of an unprocessed request table, a request list, and a request sorting table, after a request is stored in a soft request queue. The process indicated by the flowchart of FIG. 15 corresponds to one example of the process at Step S5 of FIG. 12. Herein, a case where a request that includes the order number n and read by the CPU core #i is stored in the soft request queue 300 is described.

The list creating unit 102 receives an input of information on the request list 74 for the core number #i from which the request is read, from the soft request queue managing unit 104. The list creating unit 102 then determines whether a next pointer of the registration information indicated by the head registration information 700 in the request list 74 for the core number #1 represents the end, in other words, whether next registration information 700 is present (Step S301).

If the next pointer represents the end (Step S301: affirmative), the list creating unit 102 sets a value of the request list pointer in the entry of the core number #i in the unprocessed request table 105 to NULL (Step S302).

In contrast, if the next pointer indicates next registration information 700 (Step S301: negative), the list creating unit 102 sets a request list pointer in the entry of the core number #i in the unprocessed request table 105 as a value indicating the registration information 700 indicated by the next pointer (Step S303).

Next, the list creating unit 102 deletes the head registration information 700 in the request list 74 for the core number #i (Step S304). The list creating unit 102 then notifies the sorting unit 103 of the deletion of the head registration information 700 in the request list 74 for the core number #i.

The sorting unit 103 receives the notification of the deletion of the head registration information 700 in the request list 74 for the core number #i, from the list creating unit 102. The sorting unit 103 then moves the head index 64 in the request sorting table 106 to the next entry. Moreover, the sorting unit 103 changes a value of a reader core in the entry indicated by the head index 64 before the movement to −1. In addition, the sorting unit 103 increments the minimum unprocessed order number 63 by one (Step S305).

Next, the sorting unit 103 determines whether the registration information 700 is present in the individual request list 70 of the CPU core #i depending on whether a value of the request list pointer in the entry of the core number #i in the unprocessed request table 105 is NULL (Step S306). If no registration information 700 is present in the individual request list 70 of the CPU core #i (Step S306: negative), the sorting unit 103 ends the change process of the request sorting table 106.

In contrast, if the registration information 700 is present in the individual request list 70 of the CPU core #i (Step S306: affirmative), the sorting unit 103 acquires the order number n of the head registration information in the request list 74 for the core number #i. Next, the sorting unit 103 determines whether the order number n is less than an addition result of the minimum unprocessed order number 63 and the number of entries in the request sorting table 106 (Step S307). If the order number n is equal to or more than the addition result (Step S307: negative), the sorting unit 103 ends the change process of the request sorting table 106.

In contrast, if the order number n is less than the addition result (Step S307: affirmative), the sorting unit 103 registers the core number #i to the entry of a cyclic number in the request sorting table 106 corresponding to the order number n (Step S308).

As described above, the information processing apparatus according to the first embodiment reads requests in the order that the requests are stored in the request queue of the device using the exclusive control, and allocates sequential order numbers so as to be the order of reading with respect to the read requests. Further, the information processing apparatus according to the first embodiment creates a list in which the requests are arranged in the order of reading for each CPU core having read, sorts the requests in the order of the order numbers using the created list, and acquires and stores the requests in the order of sorting in the soft request queue.

This allows the requests to be stored in the soft request queue while keeping the order that the requests are stored in the request queue of the device. Moreover, this also may shorten the period during when the exclusive control is performed, and concurrently performing the processes of reading requests from the request queue of the device and storing the requests in soft request queue may shorten the time. Moreover, the exclusive control is limited in a period during when a request is read and an order number is set to allow an useless process to be reduced when a request is not unable to be read, in other words, when the polling is failed.

Moreover, in a case of the communication using the InfiniBand, it is significantly difficult to distinguish the delivery delay of packet from the packet loss on the network. Therefore, a configuration in which an order number of the request is allocated at the transmission side may cause such a problem, when packets are not delivered, that requests having the same order number are transmitted, or requests are transmitted while some order number being skipped. The configuration in which an order number of the request is allocated at the transmission side is difficult to solve this problem because complicated transmission control may be performed, which is difficult to be implemented. In contrast, with the information processing apparatus according to the first embodiment, order numbers are allocated at the reception side of requests in an InfiniBand device, so that the reliability is improved compared with a case where order numbers are allocated at the transmission side.

### Second Embodiment

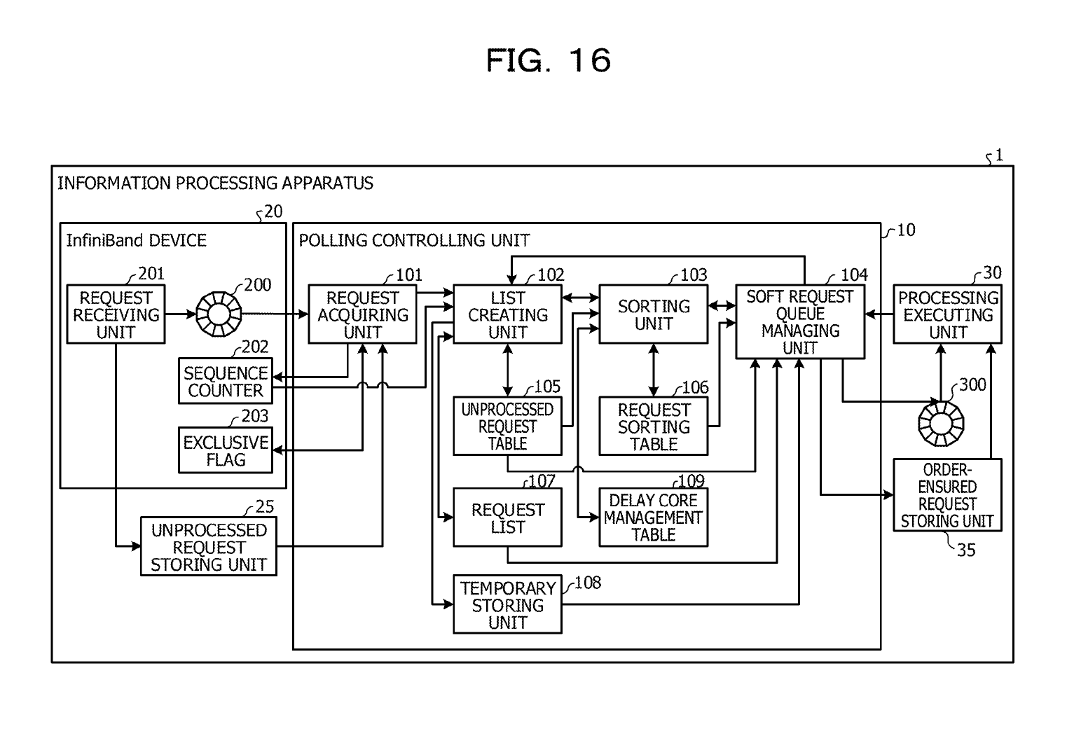

FIG. 16 is a block diagram of an information processing apparatus according to a second embodiment. The information processing apparatus 1 according to the second embodiment is different from that in the first embodiment in that in a case where no request is present when a request is read using the soft request queue 300, a sort of requests is executed to allow a request to be acquired. The information processing apparatus 1 according to the second embodiment includes a delay core management table 109, in addition to all the units described in the first embodiment. Hereinafter, explanations for the functions of the units the same as those in the first embodiment are omitted.

The processing executing unit 30 performs reading of a pointer in the soft request queue 300 in order to acquire a request. At this time, if a request is already stored in the order-ensured request storing unit 35, a pointer indicated by the request is stored in the soft request queue 300. Therefore, the processing executing unit 30 reads the pointer from the soft request queue 300, and acquires the request indicated by the read pointer from the order-ensured request storing unit 35.

In contrast, if a request is not yet stored in the order-ensured request storing unit 35, a pointer indicating the request is not stored in the soft request queue 300. Therefore, the processing executing unit 30 fails in reading of a pointer from the soft request queue 300. Therefore, the processing executing unit 30 demands storage of the request in the soft request queue 300 of the soft request queue managing unit 104.

Thereafter, when the request is stored in the soft request queue 300, the processing executing unit 30 acquires the stored request, and performs a process.

The soft request queue managing unit 104 acquires a storage demand of the request to the soft request queue 300, from the processing executing unit 30. The soft request queue managing unit 104 then acquires the head index 64 of the request sorting table 106. The soft request queue managing unit 104 then determines whether a value of a reader core in the entry of a cyclic number indicated by the head index 64 is −1.

If any one of the core numbers #0 to #(N−1) is registered as a reader core, the soft request queue managing unit 104 acquires a reader core. Next, the soft request queue managing unit 104 acquires a request list pointer corresponding to the acquired reader core from the entry of the unprocessed request table 105. The soft request queue managing unit 104 then reads the head registration information 700 of the individual request list 70 indicated by the acquired request list pointer. Thereafter, the soft request queue managing unit 104 acquires a request indicated by a request pointer of the read registration information 700 from the temporary storing unit 108.

The soft request queue managing unit 104 then stores the acquired request in the order-ensured request storing unit 35. In addition, the soft request queue managing unit 104 stores a pointer indicating the request having stored in the order-ensured request storing unit 35, at the tail end in the soft request queue 300. Thereafter, the soft request queue managing unit 104 notifies the list creating unit 102 of information on the individual request list 70 in which the read request is stored.

In contrast, if a value of a reader core is −1, the soft request queue managing unit 104 instructs the sorting unit 103 to execute an update process of the request. Thereafter, when a value of a reader core in the entry of a cyclic number indicated by the head index 64 is set, the soft request queue managing unit 104 executes the storage of the request in the soft request queue 300. Thereafter, the soft request queue managing unit 104 notifies the list creating unit 102 of information on the individual request list 70 in which the read request is stored.

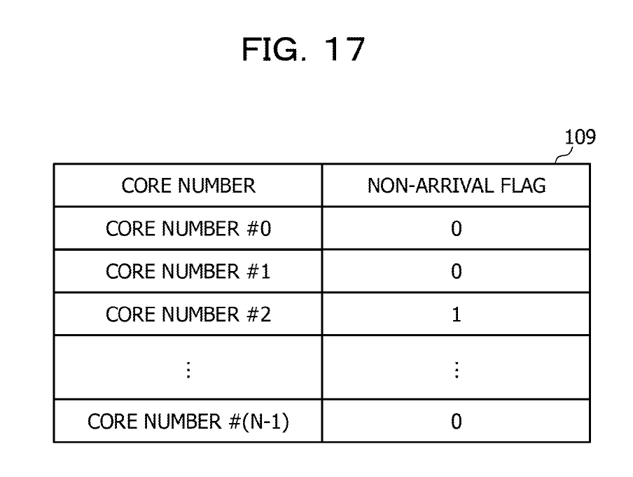

FIG. 17 is a diagram illustrating one example of a delay core management table. The delay core management table 109 is a table used when the sorting unit 103 detects the CPU core #100 in which the reflection of information on a reader core to the request sorting table 106 is delayed. The delay core management table 109 includes information on a non-arrival flag corresponding to each of the core numbers #0 to #(N−1).

The sorting unit 103 receives an instruction to execute the update process of the request, from the soft request queue managing unit 104. Next, the sorting unit 103 sets the values of all the non-arrival flags in the delay core management table 109 to 1.

Next, the sorting unit 103 selects one core number by incrementing the core number in sequence starting from the core number #0. Herein, a case where the sorting unit 103 selects the core number #i is described. The sorting unit 103 determines whether a value of a reader core in the entry of the core number #i in the request sorting table 106 is −1. If the value of the reader core is −1, the sorting unit 103 proceeds to selection of a next core number #i+1.

In contrast, if the value of the reader core is not −1, the sorting unit 103 sets the value of the non-arrival flag in the entry of the core number #i in the delay core management table 109 to 0. The sorting unit 103 then proceeds to selection of a next core number #i+1. The sorting unit 103 repeats the selection and the determination until the determination core number #(N−1). With this process, a set of the CPU cores #100 in which a value of the non-arrival flag is 0 in the delay core management table 109 becomes a set of the CPU cores #100 that do not appear in the request sorting table 106.

Next, the sorting unit 103 selects one CPU core #100 in which the value of the non-arrival flag in the delay core management table 109 is 0. The sorting unit 103 determines whether the individual request list 70 of the selected CPU core #100 is empty. If the individual request list 70 is empty, the sorting unit 103 ends the change process of the request sorting table 106 for the selected CPU core #100.

In contrast, if the individual request list 70 of the target CPU core #100 is not empty, the sorting unit 103 acquires the stored order number in the head registration information 700 of the individual request list 70. The sorting unit 103 then determines whether an addition result in which the number of entries in the request sorting table 106 is added to a value of the minimum unprocessed order number 63 is more than the acquired order number. If the addition result is less than the acquired order number, the order number is out of the registration range of the request sorting table 106, so that the sorting unit 103 ends the change process of the request sorting table 106 for the selected CPU core #100.

In contrast, if the addition result is equal to or less than the acquired order number, the sorting unit 103 adds a value in which a value of the minimum unprocessed order number 63 is subtracted from the acquired order number to the value of the head index 64. Next, the sorting unit 103 determines whether the addition result exceeds N that is the number of items in the request sorting table 106. If the addition result does not exceed N, the sorting unit 103 registers the selected CPU core #100 as a reader core to the entry of a cyclic number of the value. In contrast, if the addition result exceeds N, the sorting unit 103 registers the selected CPU core #100 as a reader core to the entry of a cyclic number in which N that is the number of items in the request sorting table 106 is subtracted from the addition result.

The sorting unit 103 repeats the selection of the CPU core #100 and the change process of the request sorting table 106 until a reader core in the entry of a cyclic number indicated by the head index 64 in the request sorting table 106 is registered or all the CPU cores #100 are completely selected.

If the reader core in the entry of a cyclic number indicated by the head index 64 in the request sorting table 106 is not registered, the sorting unit 103 determines that the request demanded by the processing executing unit 30 is not yet arrived or a delay of a process, such as the registration process to the request list 107, is generated. In this case, the sorting unit 103 notifies the processing executing unit 30 of the request being not yet arrived.

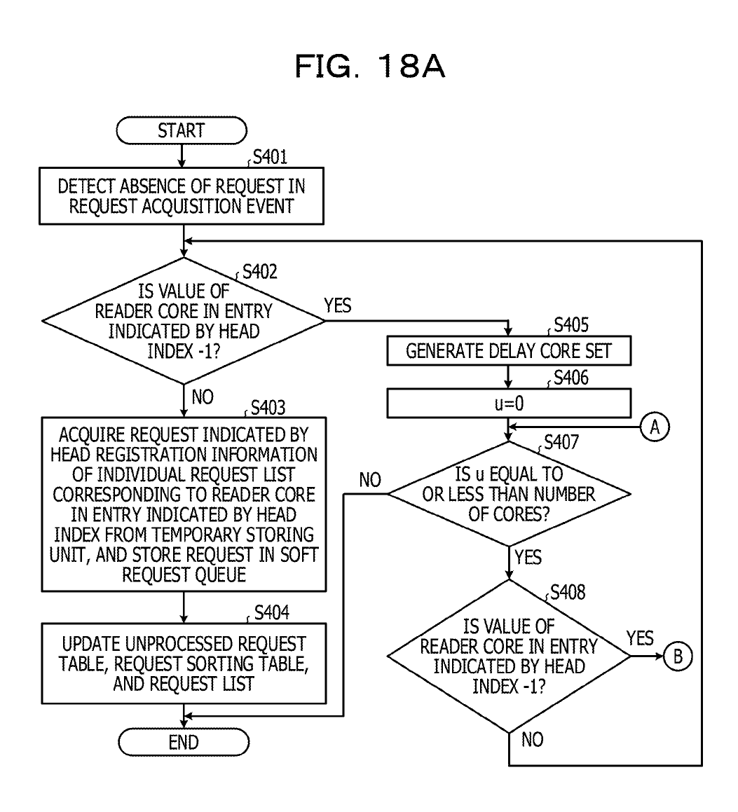

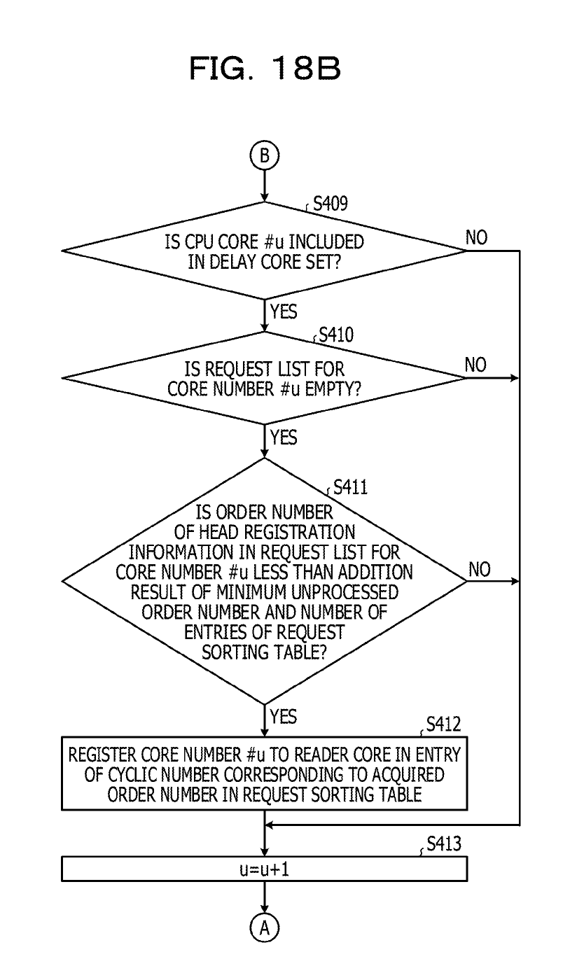

Next, a flow of a sorting process of requests in which the acquisition of the requests by an application serves as a trigger is described with reference to FIGS. 18A and 18B. FIGS. 18A and 18B indicates a flowchart of a sorting process of requests in which the acquisition of the request by an application serves as a trigger.

The processing executing unit 30 detects the absence of a request based on a failure of the reading of a pointer from the soft request queue 300 when the request is acquired (Step S401). The processing executing unit 30 then demands the storage of the request in the soft request queue 300 of the soft request queue managing unit 104.

The soft request queue managing unit 104 receives the demand of the storage of the request in the soft request queue 300, from the processing executing unit 30. The soft request queue managing unit 104 then determines whether a value of a reader core in the entry indicated by the head index 64 is −1 (Step S402).

If the value of the reader core in the entry indicated by the head index 64 is not −1 (Step S402: negative), the soft request queue managing unit 104 acquires the head registration information 700 of the individual request list 70 corresponding to a reader core in the entry indicated by the head index 64. The soft request queue managing unit 104 then acquires a request that is indicated by the acquired registration information 700 and stored in the temporary storing unit 108, and stores the request in the soft request queue 300 (Step S403). The soft request queue managing unit 104 notifies the list creating unit 102 of information on the individual request list 70 that stores therein the registration information 700 indicating the request having been stored in the soft request queue 300.

Next, the list creating unit 102 and the sorting unit 103 execute an update process of the unprocessed request table 105, the request sorting table 106, and the request list 107 (Step S404). The process illustrated in the flowchart of FIG. 15 corresponds to one example of the process performed at Step S404.

In contrast, if the value of the reader core in the entry indicated by the head index 64 is −1 (Step S402: affirmative), the sorting unit 103 uses the delay core management table 109 to generate a delay core set (Step S405).

Next, the sorting unit 103 sets u of a core number #u to 0 (Step S406). The sorting unit 103 then determines whether u is equal to or less than the number of cores (Step S407). If u is more than the number of cores (Step S407: negative), the sorting unit 103 ends the sorting process of the requests.

In contrast, if u is equal to or less than the number of cores (Step S407: affirmative), the sorting unit 103 determines whether a value of a reader core in the entry indicated by the head index 64 is −1 (Step S408). If the value of the reader core in the entry indicated by the head index 64 is not −1 (Step S408: negative), the request demanded by the processing executing unit 30 is already stored in the soft request queue 300, and thus the process returns to Step S402.

In contrast, if the value of the reader core in the entry indicated by the head index 64 is −1 (Step S408: affirmative), the sorting unit 103 checks a non-arrival flag of the core number #u in the delay core management table 109. The sorting unit 103 then determines whether a CPU core #u is included in a delay core set (Step S409). If the CPU core #u is not included in the delay core set (Step S409: negative), the sorting unit 103 causes the process to proceed to Step S413.

In contrast, if the CPU core #u is included in the delay core set (Step S409: affirmative), the sorting unit 103 checks a request list pointer in the unprocessed request table 105. The sorting unit 103 then determines whether a request list for the core number #u is empty (Step S410). If the request list for the core number #u is not empty (Step S410: negative), the sorting unit 103 causes the process to proceed to Step S413.

In contrast, if the request list for the core number #u is empty (Step S410: affirmative), the sorting unit 103 acquires an order number of head registration information in the request list for the core number #u. The sorting unit 103 then determines whether the acquired order number is less than an addition result of the minimum unprocessed order number 63 and the number of entries in the request sorting table 106 (Step S411). If the order number is equal to or more than the addition result (Step S411: negative), the sorting unit 103 causes the process to proceed to Step S413.

In contrast, if the order number is less than the addition result (Step S411: affirmative), the sorting unit 103 registers the core number #u to a reader core in the entry of the cyclic number corresponding to the acquired order number in the request sorting table 106 (Step S412).

Thereafter, the sorting unit 103 increments u by one (Step S413), and returns the process to Step S407.

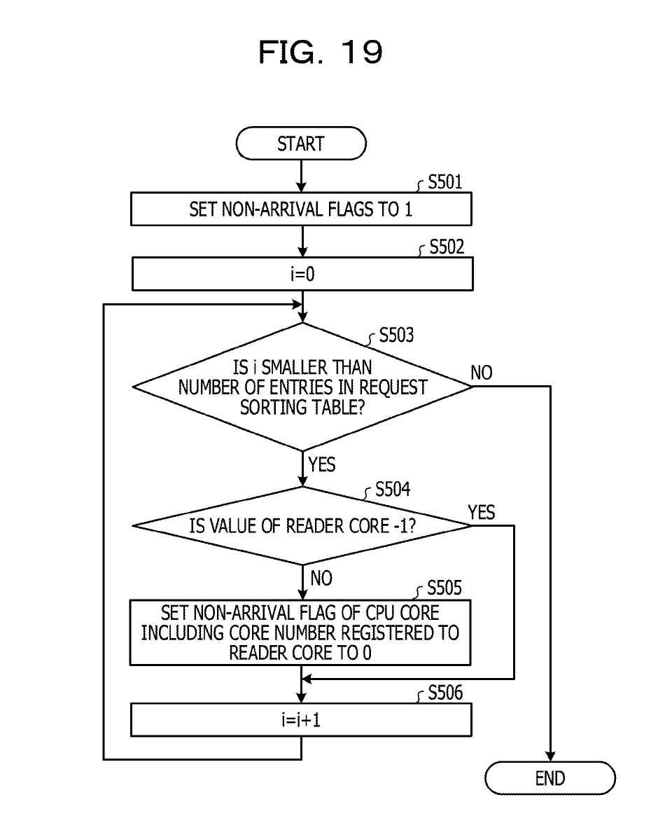

Next, a flow of a delay core set generating process by the sorting unit 103 is described with reference to FIG. 19. FIG. 19 is a flowchart of a delay core set generating process. The process illustrated by the flowchart of FIG. 19 corresponds to one example of the process at Step S405 in FIG. 18A.

The sorting unit 103 sets non-arrival flags corresponding to all the core numbers #0 to #(N−1) in the delay core management table 109 to “1” (Step S501).

Next, the sorting unit 103 sets i in an arbitrary entry i in the request sorting table 106 to 0 (Step S502).

Next, the sorting unit 103 determines whether i is smaller than the number of entries N in the request sorting table 106 (Step S503). If i is equal to or more than the number of entries N in the request sorting table 106 (Step S503: negative), the sorting unit 103 ends the delay core set generating process.

In contrast, if i is smaller than the number of entries N in the request sorting table 106 (Step S503: affirmative), the sorting unit 103 determines whether a value of a reader core corresponding to the core number #i in the request sorting table 106 is “−1” (Step S504). If the value of the reader core is “−1” (Step S504: affirmative), the sorting unit 103 causes the process to proceed to Step S506.

In contrast, if the value of the reader core is not “−1” (Step S504: negative), the sorting unit 103 acquires the core number that is registered in the entry of a reader core corresponding to the core number #i in the request sorting table 106. The sorting unit 103 then sets a non-arrival flag of the CPU core #100 including the acquired core number in the delay core management table 109 to “0” (Step S505).

Thereafter, the sorting unit 103 increments i by one (Step S506), and causes the process to return to Step S503.

As described above, the information processing apparatus according to the second embodiment updates the request sorting table in a case where no request is present when the application reads a request using the soft request queue. Specifically, the information processing apparatus detects a request in which the reception from the request queue included in the device is not reflected to the request sorting table, and causes the reception to be reflected, and thereafter stores the request in the soft request queue. This allows the application to prepare the acquisition of a request in accordance with the use of the request, and to be efficiently operated.

Herein, the information processing apparatus updates the request sorting table in a case where a request is received from the request queue included in the device, which serves as a trigger, in the first embodiment. Moreover, the information processing apparatus updates the request sorting table in a case where a request is read by the application from the soft request queue, which serves as a trigger, in the second embodiment. Further, the request sorting table may be updated using either one of the cases as a trigger, or concurrently using the both cases.

### Third Embodiment

Next, a third embodiment is described. An information processing apparatus according to the third embodiment is also illustrated in the block diagram of FIG. 2. The information processing apparatus 1 according to the third embodiment is different from that in the first embodiment in that the order of requests is ensured for each node of a transmission in the InfiniBand. Hereinafter, explanations for the functions of the units the same as those in the first embodiment are omitted.

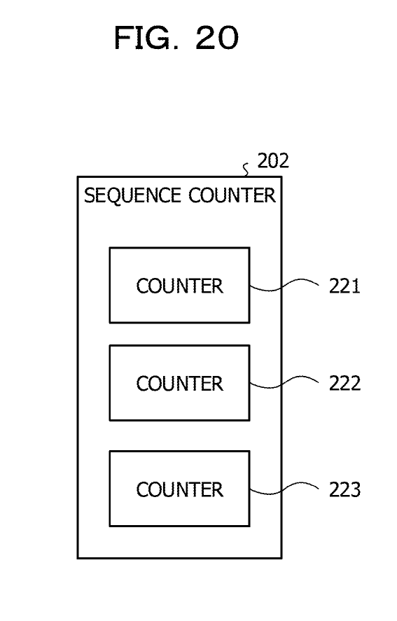

The information processing apparatus 1 according to the third embodiment includes the sequence counter 202 as illustrated in FIG. 20. FIG. 20 is a diagram of one example a sequence counter according to the third embodiment. The sequence counter 202 according to the third embodiment includes counters 221 to 223 for the respective information processing apparatuses 2 to 4 that are coupled to the interconnect 5 of the InfiniBand. For example, the counter 221 corresponds to the information processing apparatus 2, the counter 222 corresponds to the information processing apparatus 3, and the counter 223 corresponds to the information processing apparatus 4.

When the request receiving unit 201 receives a request from any one of the information processing apparatuses 2 to 4 via the interconnect 5, the request receiving unit 201 stores the request after adding information on a transmission source of the received request thereto, in the unprocessed request storing unit 25.

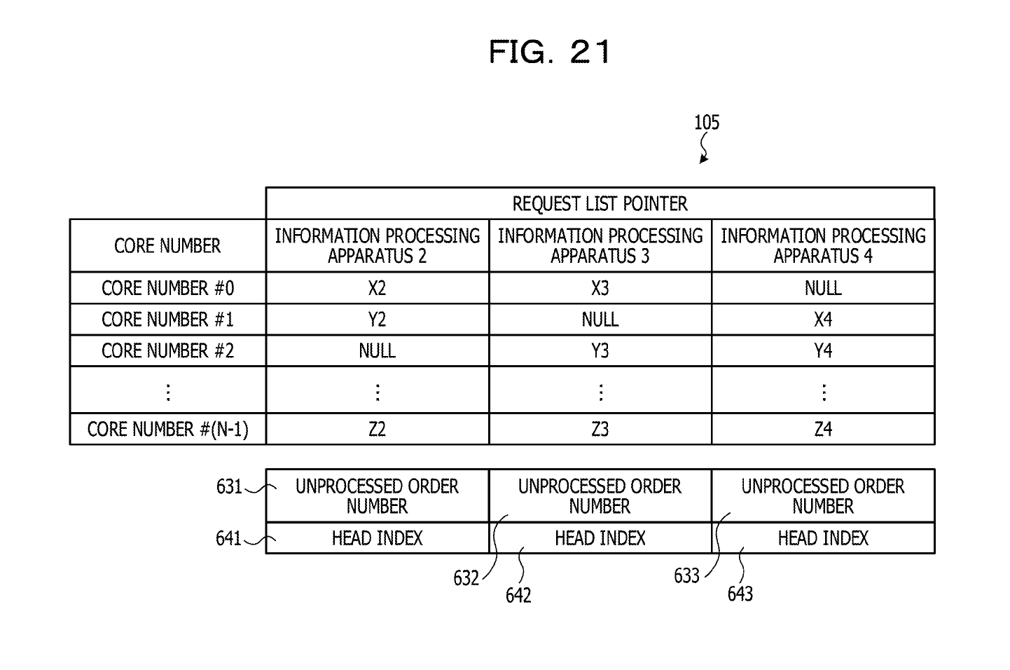

FIG. 21 is a diagram of one example of an unprocessed request table according to the third embodiment. In the unprocessed request table 105 according to the third embodiment, as illustrated in FIG. 21, request pointers are registered so as to be corresponded to core numbers #1 to #(N−1) for each of the information processing apparatuses 2 to 4. In addition, the unprocessed request table 105 according to the third embodiment includes minimum unprocessed order numbers 631 to 633 and the head indices 641 to 643 for each of the information processing apparatuses 2 to 4.

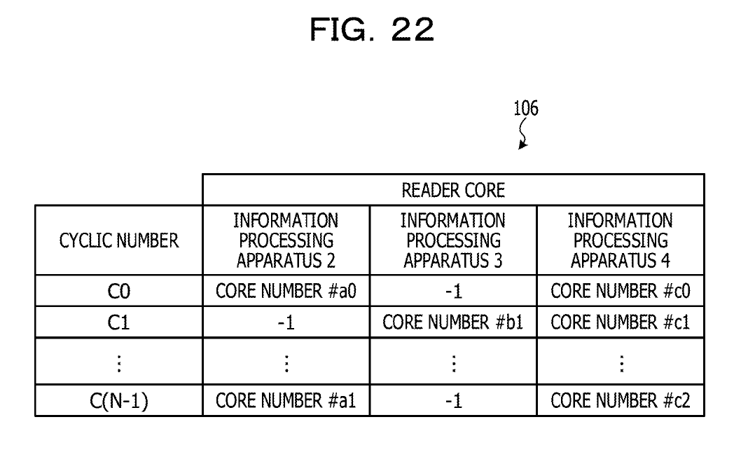

Moreover, FIG. 22 is a diagram of one example of a request sorting table according to the third embodiment. In the request sorting table 106 according to the third embodiment, as illustrated in FIG. 22, reader cores are registered so as to be corresponded to cyclic numbers C0 to C(N−1) for each of the information processing apparatuses 2 to 4.

The request acquiring unit 101 checks the exclusive flag 203 to determine whether the request queue 200 is under the exclusive control. If the request queue 200 is not under the exclusive control, the request acquiring unit 101 changes the value of the exclusive flag 203 to in-use, and locks the request queue 200.

Next, the request acquiring unit 101 executes polling for the request queue 200. The request acquiring unit 101 acquires a request indicated by a pointer stored in the request queue 200 from the unprocessed request storing unit 25. Next, the request acquiring unit 101 acquires information on a transmission source that has been added to the acquired request.

The request acquiring unit 101 then increments any one of the counters 221 to 223 corresponding to the transmission source in the sequence counter 202 by one. For example, when the transmission source of the request is the information processing apparatus 2, the request acquiring unit 101 increments the counter 221 by one. Thereafter, the request acquiring unit 101 outputs the acquired request with the information on the transmission source to the list creating unit 102. Thereafter, the request acquiring unit 101 releases the lock on the sequence counter 202.

The list creating unit 102 receives an input of the request with the information on the transmission source from the request acquiring unit 101. The list creating unit 102 then acquires a value from any one of the counters 221 to 223 corresponding to the transmission source. The list creating unit 102 then sets the acquired value as an order number of the acquired request. This allows the list creating unit 102 to allocate order numbers that are sequential numbers to requests for each of the information processing apparatuses 2 to 4.

Thereafter, the list creating unit 102 stores the acquired request in the temporary storing unit 108, and registers the registration information 700 to the individual request list 70 of the CPU core #100 that is the transmission source of the request. In addition, the list creating unit 102 registers request pointers so as to be corresponded to the CPU cores #100 using a row corresponding to the transmission source of the acquired request in the unprocessed request table 105 illustrated in FIG. 21.

The sorting unit 103 sorts requests for each of the information processing apparatuses 2 to 4 using the request sorting table 106 illustrated in FIG. 22.

The soft request queue managing unit 104 acquires requests in order of order numbers for each of the information processing apparatuses 2 to 4, and stores the requests in the soft request queue 300, using the request sorting table 106 illustrated in FIG. 22 and the unprocessed request table 105 illustrated in FIG. 21. With this, the order of requests stored in the soft request queue 300 is ensured for each of the information processing apparatuses 2 to 4.

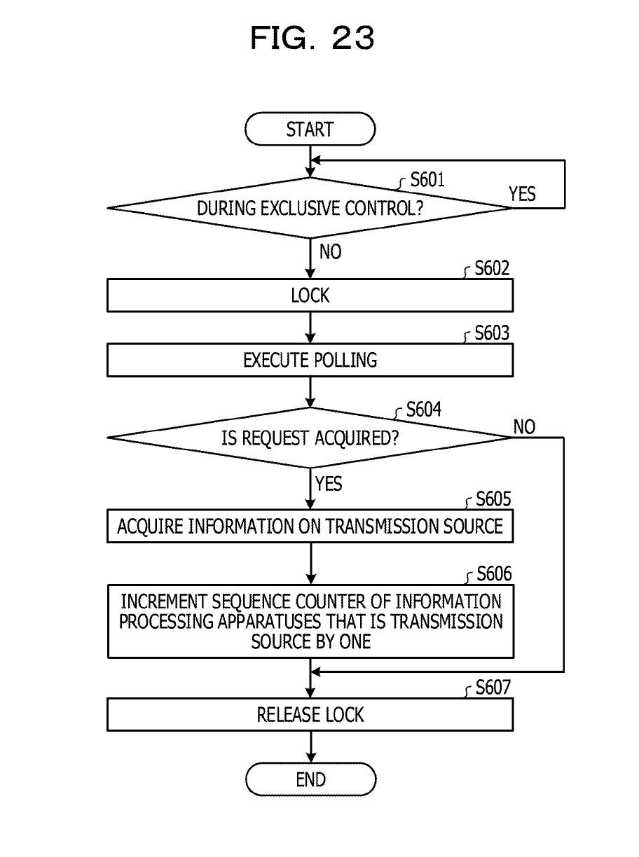

Next, a polling process by the information processing apparatus 1 according to the third embodiment is described with reference to FIG. 23. FIG. 23 is a flowchart of a request acquiring process using the exclusive control by the information processing apparatus according to the third embodiment.

The request acquiring unit 101 checks the exclusive flag 203, and determines whether the request queue 200 is in-use (Step S601). If the request queue 200 is in-use (Step S601: affirmative), the request acquiring unit 101 waits until the request queue 200 is out of use.

In contrast, if the request queue 200 is unused (Step S601: negative), the request acquiring unit 101 changes the value of the exclusive flag 203 to be in-use, and locks the request queue 200 (Step S602).

Next, the request acquiring unit 101 executes polling for the request queue 200 (Step S603).

The request acquiring unit 101 then determines whether a request is acquired (Step S604). It a request is not acquired (Step S604: negative), the request acquiring unit 101 causes the process to proceed to Step S607.

In contrast, if a request is acquired (Step S604: affirmative), the request acquiring unit 101 acquires information on a transmission source of the acquired request (Step S605).

Next, the request acquiring unit 101 increments any one of the counters 221 to 223 corresponding to any one of the information processing apparatuses 2 to 4 that is a transmission source of the request in the sequence counter 202 (Step S606).

Thereafter, the request acquiring unit 101 sets again the value of the exclusive flag 203 to unused, and releases the lock on the request queue 200 (Step S607).

As described above, the information processing apparatus according to the third embodiment stores a request in the soft request queue for each node in the communication using the InfiniBand while the request order is ensured. This allows the requests to be stored in the soft request queue while keeping the order that the requests are stored in the request queue of the device for each node. In this case, the order of requests between different nodes is not ensured.

Some applications, such as an application that executes a process for each node, are able to execute a process without keeping the order of requests between nodes. Therefore, only keeping the order of requests for each node may be sufficient for some applications. This case may reduce the time for waiting for the arrival of the request to another node when a request is moved to a soft request queue of each node, and may shorten the time for storing the request in the soft request queue.

(Hardware Configuration)

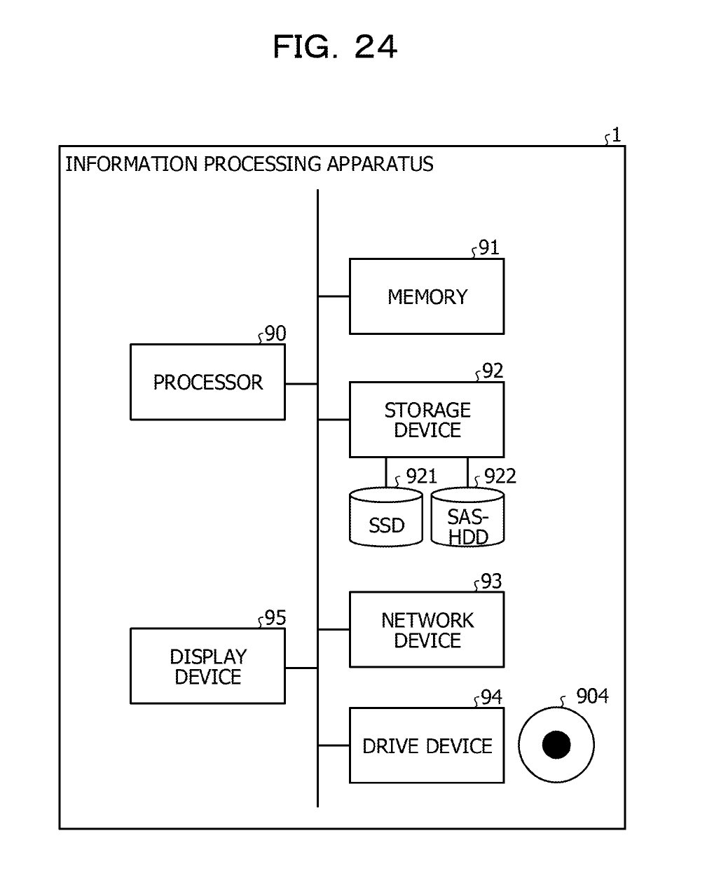

FIG. 24 is an hardware configuration diagram of the information processing apparatus. The information processing apparatus 1 includes, as illustrated in FIG. 1, a processor 90, a memory 91, a storage device 92, a network device 93, a drive device 94, and a display device 95.

The processor 90 includes the multi-core CPU 100 exemplified in FIG. 1. The processor 90 is coupled to the memory 91, the storage device 92, the network device 93, the drive device 94, and the display device 95, via a bus.

The storage device 92 includes an SSD 921 and a serial attached small computer system interface (SAS)-hard disc drive (HDD) 922. The storage device 92 includes the NVMe device 21 exemplified in FIG. 1. The network device 93 includes the InfiniBand device 20 exemplified in FIG. 1.

The drive device 94 is a compact disk (CD) drive, a digital versatile disc (DVD) drive, or the like. The drive device 94 reads or write data from or to a recording medium 904 that is a CD or a DVD. The display device 95 is, for example, a monitor.

The memory 91 implements the functions of the temporary storing unit 108, the order-ensured request storing unit 35, and the soft request queue 300 exemplified in FIG. 2. Moreover, the memory 91 stores therein various kinds of programs including a program for implementing the functions of the list creating unit 102, the sorting unit 103, the soft request queue managing unit 104, and the processing executing unit 30. Moreover, the memory 91 stores therein the unprocessed request table 105, the request sorting table 106, and the request list 107 exemplified in FIG. 1.

The processor 90 reads various kinds of programs including a program for implementing the functions of the request acquiring unit 101, the list creating unit 102, the sorting unit 103, the soft request queue managing unit 104, and the processing executing unit 30 from the memory 91, and develops and executes the programs. With this, the processor 90 and the memory 91 implement the functions of the request acquiring unit 101, the list creating unit 102, the sorting unit 103, the soft request queue managing unit 104, and the processing executing unit 30.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
a first memory;
a plurality of first processors coupled to the first memory and the plurality of first processors configured to execute a first process, the first process including:
acquiring each of a plurality of processing demands stored in the first memory; and
allocating a sequential number to the plurality of processing demands in accordance with an order in which the plurality of processing demands are stored in the first memory;
a second memory; and
a second processor coupled to the second memory and the second processor configured to execute a second process, the second process including:
storing, into the second memory, the plurality of processing demands in accordance with the allocated sequential number;
acquiring the plurality of processing demands stored in the second memory in accordance with an order in which the plurality of processing demands are stored in the second memory; and
executing a processing corresponding to each of the plurality of processing demands.

2. The information processing apparatus according to claim 1, wherein the second process further comprises:
managing the processing demands for each of the plurality of first processors having acquired the plurality of processing demands; and
sorting the plurality of processing demands based on the plurality of processing demands managed in the managing.

3. The information processing apparatus according to claim 2, wherein
the managing manages the plurality of processing demands in accordance with the order of the allocated sequential numbers for each of the plurality of first processors; and wherein
the second process further comprises:
sorting information on the plurality of first processors having acquired the plurality of processing demands in accordance with the allocated sequential numbers;
acquiring the information on the plurality of first processors in accordance with the allocated sequential numbers;
acquiring the head processing demand, among the plurality of processing demands, corresponding to the first processor, among the plurality of first processor, indicated by the acquired information;
storing, into the second memory, the head processing demand.

4. The information processing apparatus according to claim 1, wherein
the sorting sorts the plurality of processing demands and storing the plurality of processing demands into the second memory when no processing demand is not stored in the second memory at a timing of the acquiring the plurality of processing demands stored in the second memory.

5. An information processing method executed by a computer, the information processing method comprising:
acquiring, by a plurality of processors, each of a plurality of processing demands stored in a first memory;
allocating, by the plurality of processors, a sequential number to the plurality of processing demands in accordance with an order in which the plurality of processing demands are stored in the first memory;
storing, into the second memory, the plurality of processing demands in accordance with the allocated sequential number;
acquiring the plurality of processing demands stored in the second memory in accordance with an order in which the plurality of processing demands are stored in the second memory; and
executing a processing corresponding to each of the plurality of processing demands.

6. A non-transitory computer-readable storage medium storing a program that causes a computer to execute a process, the process comprising:
acquiring, by a plurality of processors, each of a plurality of processing demands stored in a first memory;
allocating, by the plurality of processors, a sequential number to the plurality of processing demands in accordance with an order in which the plurality of processing demands are stored in the first memory;
storing, into the second memory, the plurality of processing demands in accordance with the allocated sequential number;
acquiring the plurality of processing demands stored in the second memory in accordance with an order in which the plurality of processing demands are stored in the second memory; and
executing a processing corresponding to each of the plurality of processing demands.
